(19) United States
(12) Patent Application Publication
(10) Pub. No.: US 2022/0344463 A1
(43) Pub. Date: Oct. 27, 2022

(54) INTEGRATED CIRCUIT INCLUDING DEVICES WITH VARIOUS PROPERTIES AND METHOD FOR DESIGNING THE SAME

(71) Applicant: SAMSUNG ELECTRONICS CO., LTD., Suwon-si (KR)

(72) Inventors: Hakchul Jung, Seoul (KR); Myunggil Kang, Suwon-si (KR); Jungho Do, Hwaseong-si (KR); Sanghoon Baek, Seoul (KR)

(73) Assignee: SAMSUNG ELECTRONICS CO., LTD., Suwon-si (KR)

(21) Appl. No.: 17/719,996

(22) Filed: Apr. 13, 2022

(30) Foreign Application Priority Data
Apr. 27, 2021 (KR) 10-2021-0054640
Jul. 20, 2021 (KR) 10-2021-0095162

(51) Int. Cl. H01L 29/06; H01L 27/088; H01L 29/786; H01L 23/48

(52) U.S. Cl. CPC H01L 29/0665; H01L 27/0886; H01L 29/78618; H01L 29/78696; H01L 23/481

(57) ABSTRACT

An integrated circuit may include a first cell and a second cell. The first cell includes a first transistor in which nanosheets included in a first nanosheet stack and a second nanosheet stack extend in a first direction to pass through a first gate electrode that extends in a second direction intersecting with the first direction. The second cell includes a second transistor in which one or more nanosheets included in a third nanosheet stack extends in the first direction to pass through a second gate electrode that extends in the second direction. A length of the first cell in the second direction may be greater than a length of the second cell in the second direction.

### CROSS-REFERENCE TO RELATED APPLICATIONS

This application is based on and claims priority under 35 U.S.C. § 119 to Korean Patent Application No. 10-2021-0054640, filed on Apr. 27, 2021, and Korean Patent Application No. 10-2021-0095162, filed on Jul. 20, 2021, in the Korean Intellectual Property Office, the disclosures of which are incorporated by reference herein in their entireties.

### BACKGROUND

The present disclosure relates to an integrated circuit, and more particularly, to an integrated circuit including devices with various properties and a method of designing the integrated circuit.

Devices included in an integrated circuit may have a reduced size due to development of a semiconductor process and may have a structure providing high efficiency. Devices having a reduced size may provide a high degree of integration but may have a limited performance, and thus, devices with various properties for an integrated circuit having desired performance, area, and efficiency may be required.

### SUMMARY

It is an aspect to provide an integrated circuit having desired performance, area, and efficiency by providing devices with various properties and a method of designing the integrated circuit.

According to an aspect of one or more embodiments, there is provided an integrated circuit including a first cell including a first transistor in which a plurality of nanosheets included in a first nanosheet stack and a second nanosheet stack extend in a first direction to pass through a first gate electrode that extends in a second direction intersecting with the first direction, and a second cell including a second transistor in which at least one nanosheet included in a third nanosheet stack extends in the first direction to pass through a second gate electrode that extends in the second direction, wherein a length of the first cell in the second direction is greater than a length of the second cell in the second direction.

According to another aspect of one or more embodiments, there is provided an integrated circuit including a first device region and a second device region that extend in parallel with each other in a first direction, a first device isolation layer extending in the first direction between the first device region and the second device region, a first gate electrode extending in a second direction intersecting with the first direction, a first active pattern extending in the first direction in the first device region, a second active pattern extending in the first direction between the first device isolation layer and the first active pattern, a first nanosheet stack including at least one nanosheet extending in the first direction over the first active pattern to pass through the first gate electrode, and a second nanosheet stack including at least one nanosheet extending in the first direction over the second active pattern to pass through the first gate electrode.

According to yet another aspect of one or more embodiments, there is provided an integrated circuit including a first device region and a second device region that extend in parallel with each other in a first direction, a first device isolation layer extending in the first direction between the first device region and the second device region, a first gate electrode extending in a second direction intersecting with the first direction, a plurality of first active patterns that extend in parallel with each other in the first direction in the first device region, a plurality of first nanosheet stacks that each include at least one nanosheet extending in the first direction over each of the plurality of first active patterns to pass through the first gate electrode, a plurality of second active patterns that extend in parallel with each other in the first direction in the second device region, and a plurality of second nanosheet stacks that each include at least one nanosheet extending in the first direction over each of the plurality of second active patterns to pass through the first gate electrode.

According to yet another aspect of one or more embodiments, there is provided a method of designing a cell included in an integrated circuit, the method including obtaining an input cell library defining a layout of a first cell, and generating an output cell library defining a layout of a second cell from input data, wherein the first cell includes a first transistor in which at least one nanosheet included in a first nanosheet stack extends in a first direction to pass through a first gate electrode that extends in a second direction intersecting with the first direction, and wherein the generating of the output cell library comprises adding the first transistor to the second cell, adding a second transistor, to the second cell, in which a plurality of nanosheets included in a second nanosheet stack extend in the first direction to pass through a second gate electrode that extends in the second direction in a second row adjacent to a first row having the first transistor located therein, and adding at least one pattern to the second cell to connect in parallel the first transistor to the second transistor.

### BRIEF DESCRIPTION OF THE DRAWINGS

Embodiments will be more clearly understood from the following detailed description taken in conjunction with the accompanying drawings, in which:

FIG. 1 illustrates plan views of examples of cells included in an integrated circuit according to an example embodiment;

FIGS. 2A and 2B are cross-sectional views illustrating examples of cross-sections of an integrated circuit, according to example embodiments;

FIGS. 3A to 3F are cross-sectional views illustrating examples of cross-sections of an integrated circuit, according to example embodiments;

FIGS. 4A to 4C are plan views illustrating examples of layouts of integrated circuits according to example embodiments;

FIG. 5 is a cross-sectional view illustrating a cross-section of an integrated circuit according to an example embodiment;

FIGS. 6A and 6B are plan views illustrating examples of cells included in an integrated circuit, according to example embodiments;

FIG. 7 is a plan view illustrating a layout of an integrated circuit according to an example embodiment;

FIG. 8 is a view illustrating cells included in an integrated circuit according to an example embodiment;

FIG. 9 is a plan view illustrating a layout of an integrated circuit according to an example embodiment;

FIG. 10 is a plan view illustrating a cell included in an integrated circuit according to an example embodiment;

FIGS. 11A and 11B are cross-sectional views illustrating examples of cross-sections of an integrated circuit, according to example embodiments;

FIG. 12 is a plan view illustrating a layout of an integrated circuit according to an example embodiment;

FIGS. 13A to 13E are cross-sectional views illustrating examples of cross-sections of an integrated circuit, according to example embodiments;

FIGS. 14A and 14B are cross-sectional views illustrating examples of cross-sections of an integrated circuit, according to example embodiments;

FIGS. 15A and 15B are cross-sectional views illustrating examples of cross-sections of an integrated circuit, according to example embodiments;

FIGS. 16A to 16C are cross-sectional views illustrating examples of cross-sections of an integrated circuit, according to example embodiments;

FIG. 17 is a flowchart illustrating a method of manufacturing an integrated circuit, according to an example embodiment;

FIG. 18 is a flowchart illustrating a method of designing a cell of an integrated circuit, according to an example embodiment;

FIG. 19 is a block diagram illustrating a system on chip (SoC) according to an example embodiment; and

FIG. 20 is a block diagram illustrating a computing system including a memory for storing a program according to an example embodiment.

### DETAILED DESCRIPTION

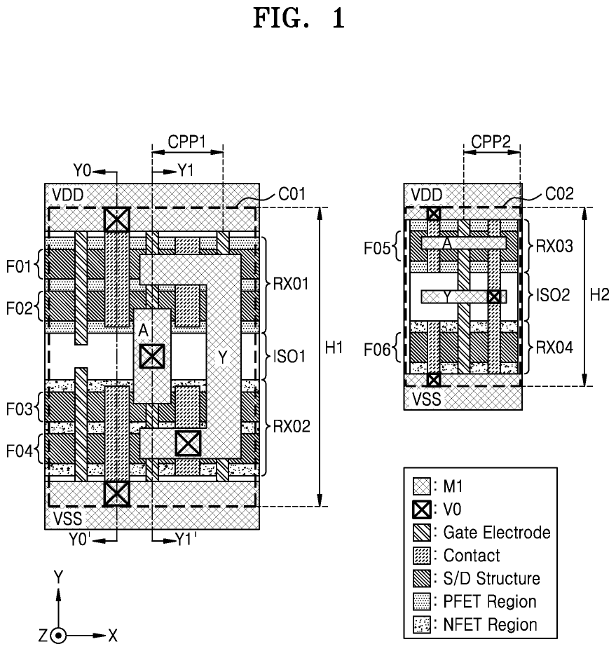

FIG. 1 illustrates plan views of examples of cells included in an integrated circuit according to an example embodiment. Specifically, the plan views of FIG. 1 schematically illustrate layouts of a first cell C01 and a second cell C02, each functioning as an inverter that generates an output signal by inverting an input signal received through an input pin A and outputs the output signal through an output pin Y, in a plane consisting of an X axis and a Y axis. Hereinafter, inverter cells will be mainly described as examples of cells, but the example embodiments are not limited thereto.

In this specification, an X-axis direction and a Y-axis direction may be respectively referred to as a first direction and a second direction, and a Z-axis direction may be referred to as a third direction or a vertical direction. A plane consisting of the X axis and the Y axis may be referred to as a horizontal plane, and a component relatively located in a +Z direction rather than other components may be referred to as being above the other components, and a component relatively located in a −Z direction rather than other components may be referred to as being below the other components. In addition, an area of a component may refer to a size occupied by the component in a plane parallel to a horizontal plane, and a width of a component may refer to a length in a direction perpendicular to a direction in which the component extends. In addition, a surface of a component exposed in the +Z direction may be referred to as an upper surface, a surface of the component exposed in the −Z direction may be referred to as a lower surface, and a surface of the component exposed in the X-axis direction or the Y-axis direction may be referred to as a side surface. In the accompanying drawings, only some layers may be illustrated for the sake of convenient illustration, and in order to indicate a connection between a pattern of an upper layer and a pattern of a lower layer, a via may be displayed over the pattern of the upper layer despite being located below the pattern of the upper layer. The accompanying drawings are intended only for reference, and are not intended to limit the example embodiments. The accompanying drawings are not to scale unless specifically indicated. In the present specification, the phrase “at least one of A, B and C” includes within its scope “only A”, “only B”, “only C”, “A and B”, “A and C”, “B and C”, and “A, B, and C”.

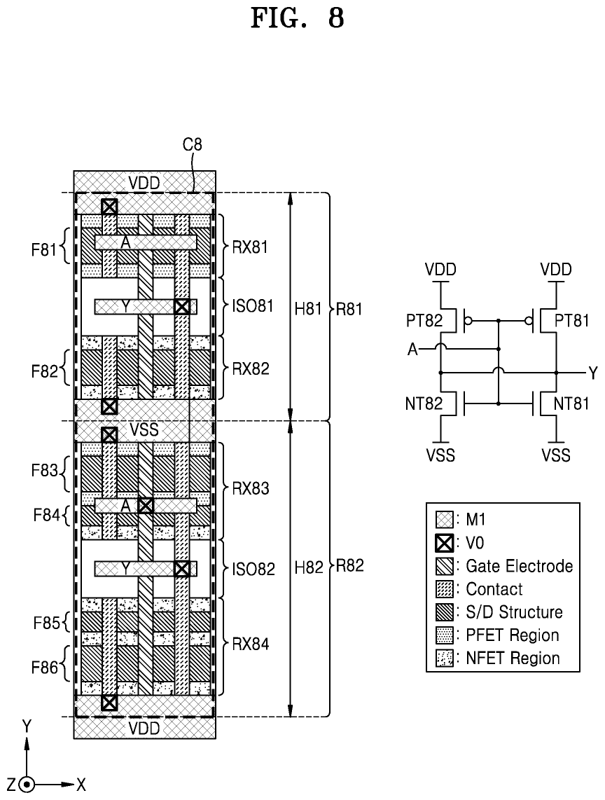

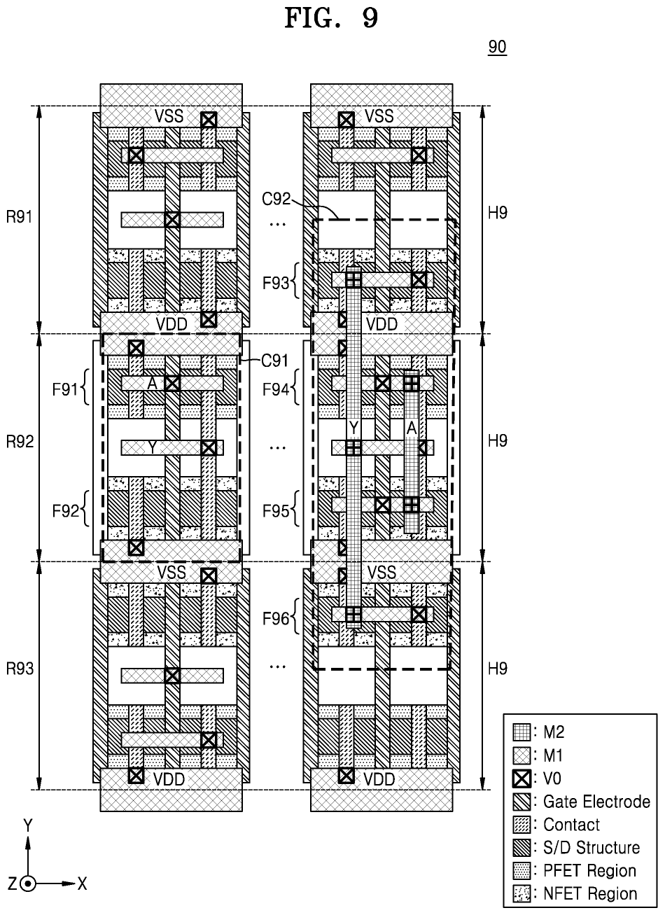

An integrated circuit may include a plurality of cells. A cell is a unit of layout included in an integrated circuit and may perform a predefined function and may be referred to as a standard cell. An integrated circuit may include many different cells, the cells may be arranged according to a plurality of rows, and a length of the cell corresponding to a width of the row may be referred to as a height of the cell. For example, as illustrated in FIG. 1, the first cell C01 may have a first height H1 in the Y-axis direction, and the first cell C01 may be located in a row extending in the X-axis direction with the same width (i.e., an extension width in the X-axis direction) as the first height H1. In addition, the second cell C02 may have a second height H2 in the Y-axis direction, and the second cell C02 may be located in a row extending in the X-axis direction with the same width (i.e., an extension width in the X-axis direction) as the second height H2. Cells arranged in one row, such as the first and second cells C01 and C02 in FIG. 1, may be referred to as single height cells, and cells arranged consecutively in two or more adjacent rows, such as an inverter cell C8 of FIG. 8 and a second cell C92 of FIG. 9, may be referred to as multiple height cells.

As illustrated in FIG. 1, patterns of M1 layers for supplying a positive supply voltage VDD and a negative supply voltage VSS (or a ground potential) to the first and second cells C01 and C02 may extend in the X-axis direction along a boundary between rows, and the corresponding patterns may be referred to as power rails. In addition, the device regions may extend in the X-axis direction in the row, and the device isolation layer may extend in the X-axis direction between the device regions. For example, in the first cell C01, a first device region RX01 in which a p-channel field effect transistor (PFET) is formed and a second device region RX02 in which an n-channel field effect transistor (NFET) is formed may extend in the X-axis direction, and a first device isolation layer IS01 may extend in the X-axis direction between the first and second device regions RX01 and RX02. In addition, in the second cell C02, a third device region RX03 in which a PFET is formed and a fourth device region RX04 in which an NFET is formed may extend in the X-axis direction, and a second device isolation layer IS02 may extend in the X-axis direction between the third and fourth device regions RX03 and RX04. In some embodiments, an n-type impurity may be injected into the first device region RX01, and a p-type impurity may be injected into the second device region RX02. The device regions RX01 to RX04 may be referred to as active regions.

In a device region, at least one active pattern may extend in the X-axis direction, and a source, a drain, and a channel of the transistor may be formed on the active pattern. For example, a first active pattern F01 and a second active pattern F02 may extend in the X-axis direction in the first device region RX01 of the first cell C01, and a third active pattern F03 and a fourth active pattern F04 may extend in the X-axis direction in the second device region RX02 of the first cell C01. In addition, a fifth active pattern F05 may extend in the X-axis direction in the third device region RX03 of the second cell C02, and a sixth active pattern F06 may extend in the X-axis direction in the fourth device region RX04 of the second cell C02. In FIG. 1, the active patterns are not illustrated because of being covered by a source/drain structure and a gate electrode. In addition, although FIG. 1 illustrates that source/drain structures formed over each of the first and second active patterns F01 and F02 are spaced apart from each other in the Y-axis direction, the source/drain structures formed on active patterns extending in the same device region may be connected to each other.

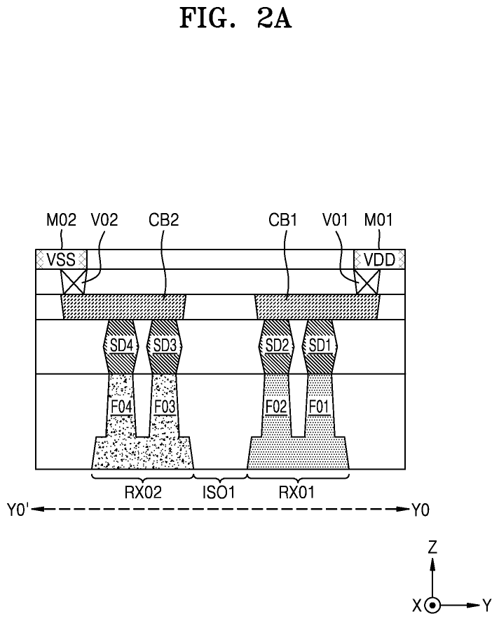

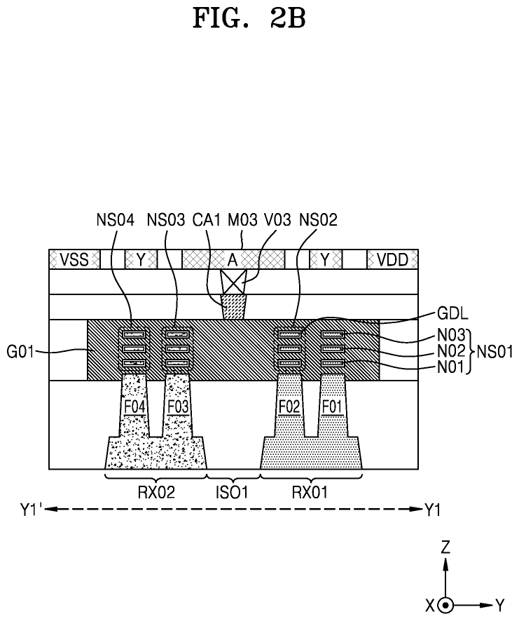

As described below with reference to FIGS. 2A and 2B illustrating cross-sections of the first cell C01 respectively taken along line Y0-Y0′ and line Y1-Y1′, respectively, at least one nanosheet may extend in the X-axis direction through a gate electrode in a region where an active pattern intersects with a gate electrode. The gate electrode may at least partially surround each of at least one nanosheet, and the nanosheet may be connected to source/drain structures located on both sides of the gate electrode. As such, a transistor in which a channel is formed by at least one nanosheet passing through the gate electrode may be referred to as a multi-bridge channel field effect transistor (MBCFET), and the first and second cells C01 and C02 may each include an MBCFET.

As illustrated in FIG. 1, the second cell C02 may include one active pattern extending in a device region (i.e., one active pattern per device region), and the first cell C01 may include two active patterns extending in a device region (i.e., two active patterns per device region). Accordingly, devices of the first cell C01, that is, transistors, may have a larger channel cross-sectional area than transistors of the second cell C02. Accordingly, the transistors of the first cell C01 may have a relatively high current driving capability, and the first cell C01 may have a relatively high operating speed. Extending a width (that is, a length in the Y-axis direction) of the nanosheet to increase a cross-sectional area of a channel may be limited due to difficulty of a semiconductor process. Accordingly, two or more active patterns may extend in one device region as in the first cell C01, and at least one nanosheet may be formed over each of the two or more active patterns.

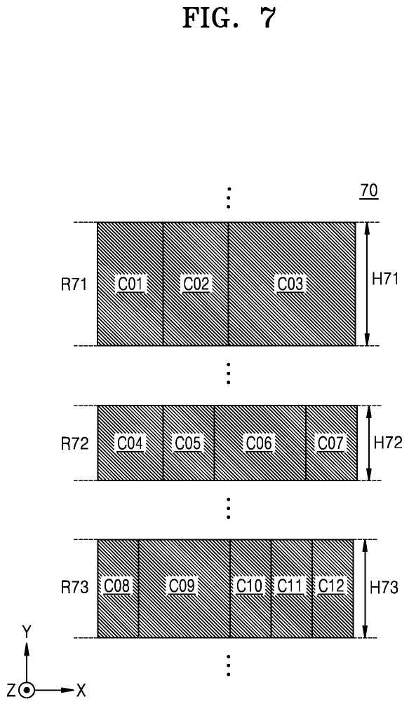

Due to the two active patterns, the total width (that is, a length in the Y-axis direction) of the first and second device regions RX01 and RX02 and the first device isolation layer IS01 of the first cell C01 may be greater than the total width (that is, a length in the Y-axis direction) of the third and fourth device regions RX03 and RX04 and the second device isolation layer IS02 of the second cell C02, and accordingly, the first height H1 of the first cell C01 may be greater than the second height H2 of the second cell C02 (H1>H2). Here, it is noted that the term “height” of the cell includes a portion of the patterns of the M1 layers for supplying the positive supply voltage VDD and the negative supply voltage VSS (or the ground potential) as illustrated by the dashed lines demarcating the first and second cells C01 and C02 in FIG. 1. In some embodiments, an integrated circuit may include the first cell C01 and the second cell C02, and thus, the integrated circuit may include rows of different heights in the Y-axis direction, as described below with reference to FIG. 7.

In some embodiments, a first pitch CPP1 between gate electrodes in the X-axis direction in the first cell C01 may be greater than a second pitch CPP2 between gate electrodes in the X-axis direction in the second cell C02 (CPP1>CPP2). Accordingly, in the first cell C01, an area of a source/drain contact between the gate electrodes and an area of a gate contact over the gate electrode may increase, and resistance of a wire may be reduced. The pitch between the gate electrodes may be referred to as a contacted poly pitch (CPP). In addition, due to the increased first pitch CPP1 and first height H1, widths of and/or a pitch between patterns of a wiring layer (for example, an M1 layer) in the first cell C01 may increase, and a cross-sectional area of a via may be increased. Accordingly, resistances and capacitances of wires may be further reduced. In addition, differently from the second cell C02 including patterns of the M1 layer extending in the X-axis direction, the first cell C01 may include the patterns of the M1 layer extending in the X-axis direction and/or the Y-axis direction. For example, an output pin Y of the first cell C01 may include portions extending in the X-axis direction and a portion extending in the Y-axis direction. Accordingly, the first cell C01 may be easily performed, and the first cell C01 may have a more efficient wiring structure.

Cells providing the same function but having different properties, such as the first cell C01 and the second cell C02, may be provided, and thus, integrated circuits satisfying requirements may be easily configured and manufactured, and the time to market the integrated circuits may be reduced. In addition, a performance, an area, and efficiency of integrated circuits may be optimized due to cells having various properties.

FIGS. 2A and 2B are cross-sectional views illustrating examples of cross-sections of an integrated circuit, according to an example embodiment. Specifically, the cross-sectional view of FIG. 2A illustrates an example of a cross-section taken along line Y0-Y0′ of the first cell C01 of FIG. 1, and the cross-sectional view of FIG. 2B illustrates an example of a cross-section taken along line Y1-Y1′ of the first cell C01 of FIG. 1. Hereinafter, like designators refer to like components and repeated descriptions already given above are omitted from the description of FIGS. 2A and 2B for conciseness.

Referring to FIG. 2A, the first device region RX01, the first device isolation layer IS01, and the second device region RX02 may be sequentially arranged in the Y-axis direction. In the first device region RX01, the first and second active patterns F01 and F02 may extend in parallel with each other in the X-axis direction. In the second device region RX02, the third and fourth active patterns F03 and F04 may extend in parallel with each other in the X-axis direction. As illustrated in FIG. 2A, each of the first to fourth active patterns F01 to F4 may have a fin shape and may also be referred to as a fin-type active pattern. A first source/drain structure SD1, a second source/drain structure SD2, a third source/drain structure SD3, and a fourth source/drain structure SD4 may be respectively formed on the first to fourth active patterns FO1 to F04. As described above with reference to FIG. 1, in some embodiments, differently from the structures illustrated in FIG. 2A, the first source/drain structure SD1 may be connected to the second source/drain structure SD2 in the Y-axis direction, and the third source/drain structure SD3 may be connected to the fourth source/drain structure SD4 in the Y-axis direction. In some embodiments, the first to fourth source/drain structures SD1 to SD4 may be formed by an epitaxial growth method.

A first source/drain contact CB1 may be formed on the first and second source/drain structures SD1 and SD2, and the first source/drain contact CB1 may be connected to the first pattern MO1 through a first via V01. In addition, a second source/drain contact CB2 may be formed on the third and fourth source/drain structures SD3 and SD4, and the second source/drain contact CB2 may be connected to the second pattern M02 through a second via V02.

Referring to FIG. 2B, a first nanosheet stack NS01, a second nanosheet stack N502, a third nanosheet stack N503, and a fourth nanosheet stack N504 may be respectively formed over first to fourth active patterns F01 to F04. The first to fourth nanosheet stacks NS01 to N504 may each include at least one nanosheet stacked in the Z-axis direction. For example, the first nanosheet stack NS01 may include a first nanosheet N01, a second nanosheet N02, and a third nanosheet N03 stacked over the first active pattern F01 in the Z-axis direction. The first to third nanosheets N01 to N03 may extend in the X-axis direction to pass through a gate electrode G01, and a gate dielectric layer GDL may be formed between each of the first to third nanosheets N01 to N03 and the gate electrode G01. A nanosheet may provide a channel for a transistor and may be formed of a single material (for example, Si) in some embodiments. In some embodiments, differently from the structure illustrated in FIG. 2B, the first to fourth nanosheet stacks NS01 to NS04 may each include less than or more than three stacked nanosheets. Herein, it is assumed that there is a gate dielectric layer GDL between a nanosheet and a gate electrode unless otherwise specified.

The gate dielectric layer GDL may have a structure in which an interfacial layer and a high-k dielectric layer are stacked. In some embodiments, the interfacial layer may include a low-k material layer with a dielectric constant of about 9 or less, such as a silicon oxide layer, a silicon oxynitride layer, or a combination thereof. In some embodiments, the interfacial layer may be omitted. The high-k dielectric layer may include a material with a higher dielectric constant than a dielectric constant of a silicon oxide layer. For example, the high-k dielectric layer may have a dielectric constant of about 10 to about 25.

In some embodiments, the gate dielectric layer GDL may include a ferroelectric material layer with ferroelectric properties and a paraelectric material layer with paraelectric properties. The ferroelectric material layer may have a negative capacitance, and the paraelectric material layer may have a positive capacitance. When the ferroelectric material layer with a negative capacitance is connected in series to the paraelectric material layer with a positive capacitance, both capacitances of the ferroelectric material layer and the paraelectric material layer connected in series may increase. By using an increase in both capacitances thereof, a transistor including the ferroelectric material layer may have a subthreshold swing (SS) of about 60 mV/decade or less at room temperature.

The ferroelectric material layer may have ferroelectric properties. The ferroelectric material layer may include at least one of, for example, hafnium oxide, hafnium zirconium oxide, barium strontium titanium oxide, barium titanium oxide, and lead zirconium titanium oxide. For example, hafnium zirconium oxide may be a material in which zirconium (Zr) is doped into hafnium oxide. Alternatively, hafnium zirconium oxide may include a compound of hafnium (Hf), zirconium (Zr), and oxygen (O).

The ferroelectric material layer may further include a doped dopant. For example, the dopant may include at least one of aluminum (Al), titanium (Ti), niobium (Nb), lanthanum (La), yttrium (Y), magnesium (Mg), silicon (Si), calcium (Ca), cerium (Ce), dysprosium (Dy), erbium (Er), gadolinium (Gd), germanium (Ge), scandium (Sc), strontium (Sr), and tin (Sn). The type of dopant included in the ferroelectric material layer may be determined according to a ferroelectric material included in the ferroelectric material layer. When the ferroelectric material layer includes hafnium oxide, the dopant included in the ferroelectric material layer may include at least one of, for example, gadolinium (Gd), silicon (Si), zirconium (Zr), aluminum (Al), and yttrium (Y). When the dopant is aluminum (Al), the ferroelectric material layer may include aluminum of about 3 atomic % (at %) to about 8 atomic % (at %). Here, a ratio of the dopant may be a ratio of aluminum to the sum of hafnium and aluminum. When the dopant is silicon (Si), the ferroelectric material layer may include silicon of about 2 at % to about 10 at %. When the dopant is yttrium (Y), the ferroelectric material layer may include yttrium of about 2 at % to about 10 at %. When the dopant is gadolinium (Gd), the ferroelectric material layer may include gadolinium of about 1 at % to about 7 at %. When the dopant is zirconium (Zr), the ferroelectric material layer may include zirconium of about 50 at % to about 80 at %.

The paraelectric material layer may have paraelectric properties. The paraelectric material layer may include at least one of, for example, silicon oxide and a metal oxide with a high dielectric constant. The metal oxide included in the paraelectric material layer may include at least one of, for example, hafnium oxide, zirconium oxide, and aluminum oxide, but is not limited thereto.

In some embodiments, the ferroelectric material layer and the paraelectric material layer may include the same material. The ferroelectric material layer may have ferroelectric properties, but the paraelectric material layer may not have ferroelectric properties. For example, when the ferroelectric material layer and the paraelectric material layer include hafnium oxide, a crystal structure of the hafnium oxide included in the ferroelectric material layer may be different from a crystal structure of the hafnium oxide included in the paraelectric material layer.

The ferroelectric material layer may have a thickness with ferroelectric properties. The thickness of the ferroelectric material layer may be, for example, about 0.5 nm to about 10 nm, but is not limited thereto. Because a critical thickness representing ferroelectric properties may vary for each ferroelectric material, a thickness of the ferroelectric material layer may vary depending on the ferroelectric material. For example, a gate dielectric layer may include one ferroelectric material layer. In another example, the gate dielectric layer may include a plurality of ferroelectric material layers spaced apart from each other. The gate dielectric layer may have a stacked structure in which a plurality of ferroelectric material layers and a plurality of paraelectric material layers are alternately stacked.

The gate electrode G01 may surround the nanosheets included in the first to fourth nanosheet stacks NS01 to NS04. A gate contact CA1 may be formed on the gate electrode G01, and the gate contact CA1 may be connected to a third pattern M03 through a third via V03. In some embodiments, differently from the illustration of FIG. 2B, the gate electrode G01 may be connected to the third pattern M03 through one via or through one contact. In some embodiments, the gate electrode G01 may include a metal-containing layer for adjusting a work function and a metal-containing layer for gap-filling that fills an upper space of the metal-containing layer for adjusting a work function. In some embodiments, the gate electrode G01 may have a structure in which a metal nitride layer, a metal layer, a conductive capping layer, and a gap-fill metal layer are sequentially stacked.

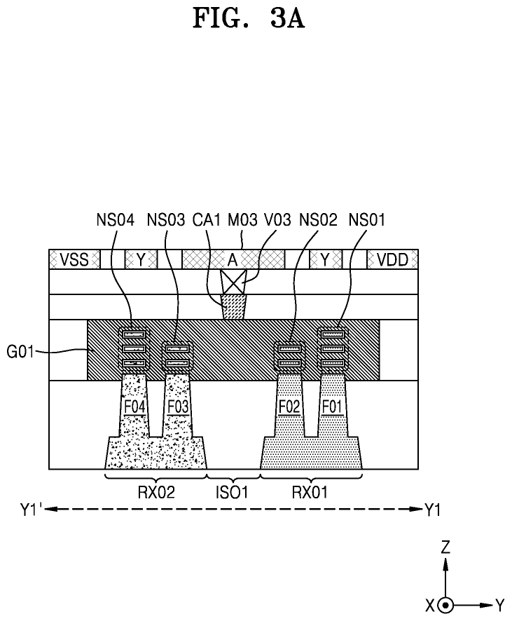

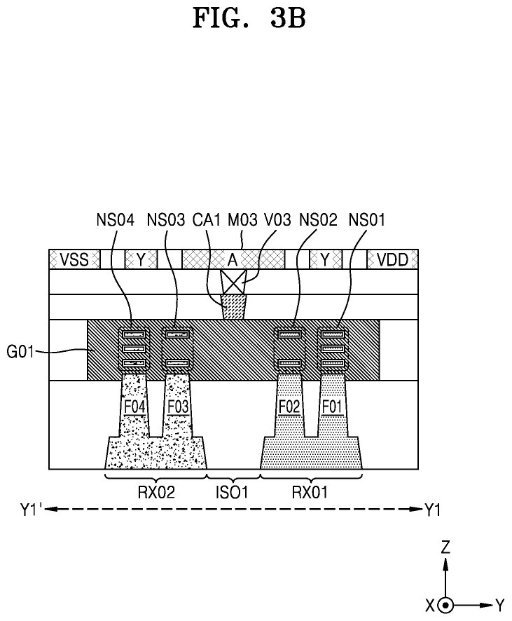

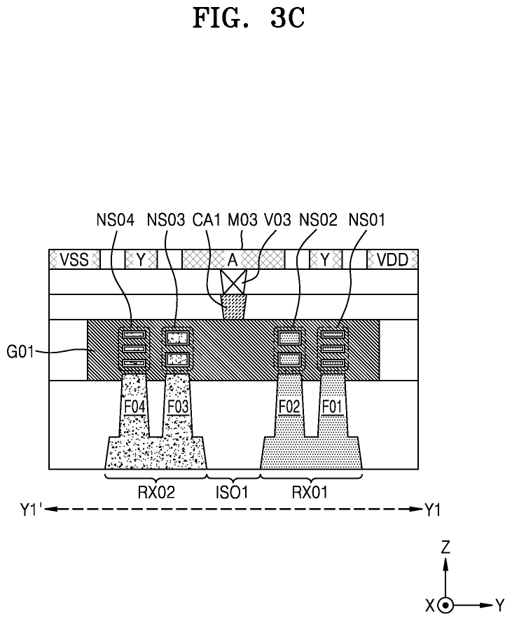

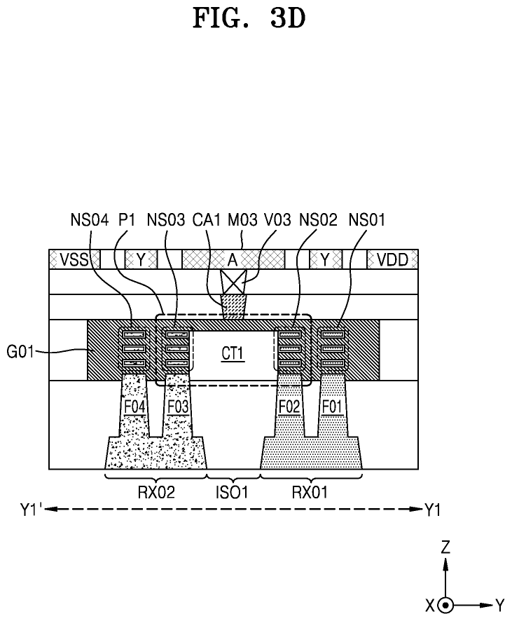

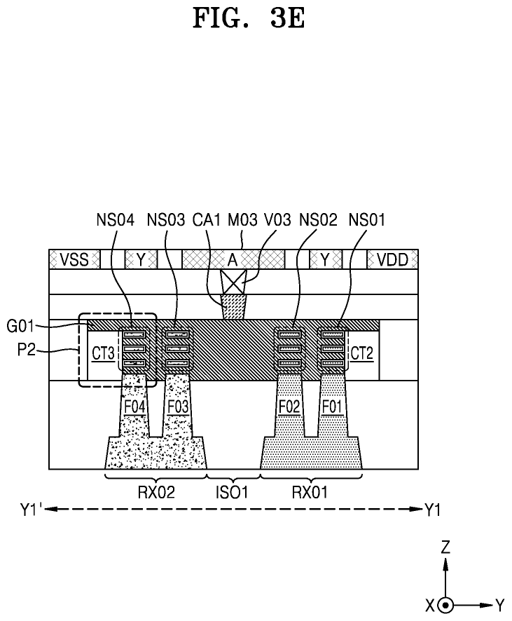

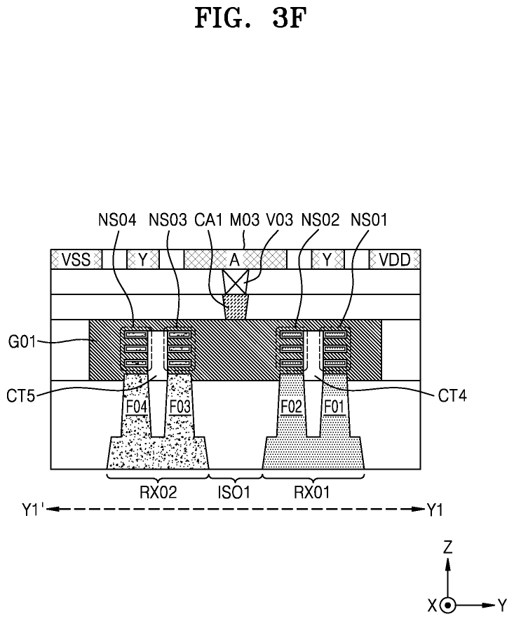

FIGS. 3A to 3F are cross-sectional views illustrating examples of cross-sections of an integrated circuit, according to example embodiments. Specifically, the cross-sectional views of FIGS. 3A to 3F illustrate examples of cross-sections taken along line Y1-Y1′ of the first cell C01 of FIG. 1. Hereinafter, in describing FIGS. 3A to 3F, like designators refer to like components and description already given with reference to FIG. 2B is omitted for conciseness.

In FIGS. 3A to 3F, the first device region RX01, the first device isolation layer IS01, and the second device region RX02 may be sequentially arranged in the Y-axis direction. First to fourth nanosheet stacks NS01 to N504 may be respectively formed over the first to fourth active patterns F01 to F04. The first to fourth nanosheet stacks NS01 to N504 may extend in the X-axis direction to pass through the gate electrode G01, and the gate electrode G01 may be connected to the third pattern M03 through the gate contact CA1 and the third via V03. As described below with reference to FIGS. 3A to 3C, nanosheet stacks may include nanosheets of various numbers, arrangements and shapes, and thus, transistors (or cells) with various properties may be provided. In addition, as described below with reference to FIGS. 3D to 3F, at least a part of the gate electrode may be removed, and thus, a gate electrode having a reduced capacitance may be provided. Although the first to fourth nanosheet stacks NS01 to N504, each including three nanosheets, are illustrated in FIGS. 3D to 3F, an insulating layer may be formed together with the nanosheet stacks including the nanosheets of various numbers, arrangements and shapes to be described below with reference to FIGS. 3A to 3C.

Referring to FIG. 3A, in some embodiments, the nanosheet stacks may each include a different number of nanosheets. For example, as illustrated in FIG. 3A, each of the first and fourth nanosheet stacks NS01 and NS04 may include three nanosheets, while the second and third nanosheet stacks NS02 and NS03 may each include two nanosheets. Accordingly, an NFET formed by the first and second nanosheet stacks NS01 and NS02 of FIG. 3A may have different characteristics from a PFET of FIG. 2B, and the third and fourth nanosheet stacks NS03 and NS04 of FIG. 3A may have different characteristics from a PFET of FIG. 2B.

Referring to FIG. 3B, in some embodiments, nanosheets may each include nanosheets spaced apart a different distance. For example, as illustrated in FIG. 3B, each of first and fourth nanosheet stacks NS01 and NS04 may include nanosheets spaced apart by a relatively short distance, while each of the second and third nanosheet stacks NS02 and NS03 may include nanosheets spaced apart by a relatively long distance. Accordingly, an NFET formed by the first and second nanosheet stacks NS01 and NS02 of FIG. 3B may have different characteristics from the NFET of FIG. 2B, and a PFET formed by the third and fourth nanosheet stacks NS03 and NS04 of FIG. 3B may have different characteristics from the PFET of FIG. 2B.

Referring to FIG. 3C, in some embodiments, nanosheet stacks may each include nanosheets of different thicknesses (that is, lengths in the Z-axis direction). For example, as illustrated in FIG. 3C, each of first and fourth nanosheet stacks NS01 and NS04 may include relatively thin nanosheets, while the second and third nanosheet stacks NS02 and NS03 may each include relatively thick nanosheets. Accordingly, an NFET formed by the first and second nanosheet stacks NS01 and NS02 of FIG. 3C may have different characteristics from the NFET of FIG. 2B, and a PFET formed by the third and fourth nanosheet stacks NS03 and NS04 of FIG. 3C may have different characteristics from the PFET of FIG. 2B.

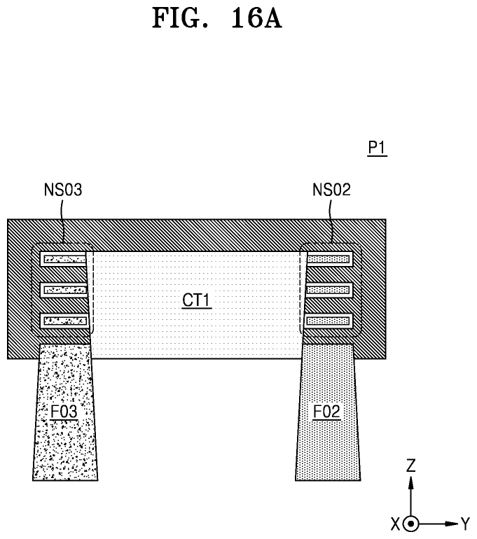

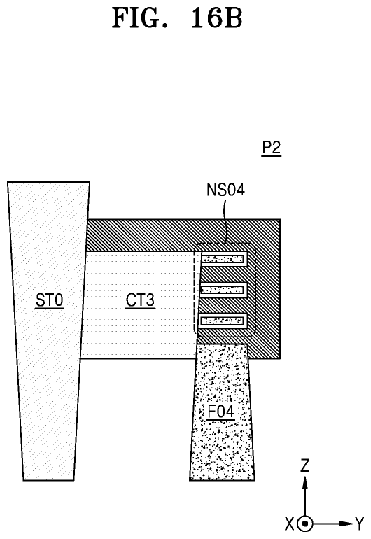

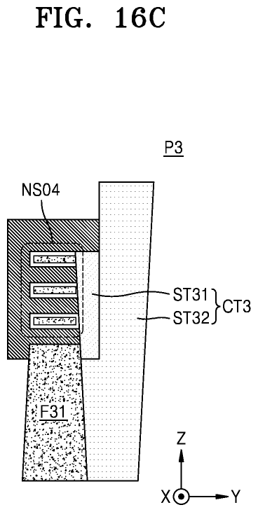

Referring to FIG. 3D, in some embodiments, a part of a gate electrode may be removed between the device regions. For example, as illustrated in FIG. 3D, a first insulating layer CT1 may be formed between second and third nanosheet stacks NS02 and NS03, and the first insulating layer CT1 may replace a lower portion of a gate electrode G01 between first and second device regions RX01 and RX02. The gate electrode G01 may have a reduced capacitance due to the portion removed by the first insulating layer CT1. In some embodiments, as illustrated in FIG. 3D, the first insulating layer CT1 may be in contact with side surfaces of the nanosheets included in the second and third nanosheet stacks NS02 and NS03. An example of a first portion P1 including the second nanosheet stack NS02, the third nanosheet stack NS03, and the first insulating layer CT1 is described below with reference to FIG. 16A.

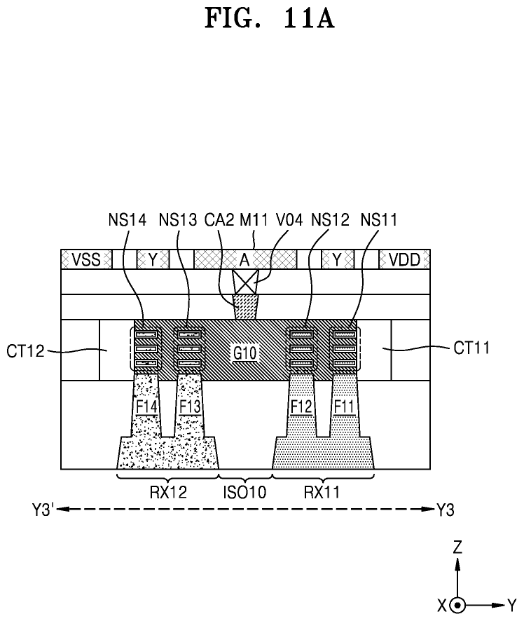

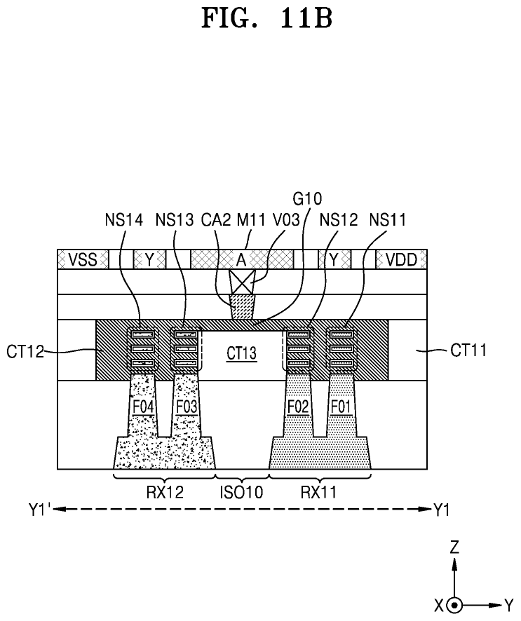

Referring to FIG. 3E, in some embodiments, a part of a gate electrode may be removed from an end of the gate electrode. For example, as illustrated in FIG. 3E, a second insulating layer CT2 may be formed adjacent to a first nanosheet NS01 of a first device region RX01 such that a portion of the second insulating layer CT2 overlaps the first device region RX01, and a third insulating layer CT3 may be formed adjacent to a fourth nanosheet stack NS04 of a second device region RX02 such that a portion of the third insulating layer CT3 overlaps the second device region RX02. The second and third insulating layers CT2 and CT3 may replace lower portions of a gate electrode G01 at ends of the gate electrode G01. The gate electrode G01 may have a reduced capacitance due to the portions removed by the second and third insulating layers CT2 and CT3. In some embodiments, as described below with reference to FIG. 11B, not only the second and third insulating layers CT2 and CT3 but also the first insulating layer CT1 of FIG. 3D may be formed together therewith. In some embodiments, as illustrated in FIG. 3E, the second insulating layer CT2 may be in contact with side surfaces of the nanosheets included in the first nanosheet stack NS01, and the third insulating layer CT3 may be in contact with side surfaces of the nanosheets included in the fourth nanosheet stack NS04. An example of a second portion P2 including the fourth nanosheet stack NS04 and the third insulating layer CT3 is described below with reference to FIG. 16B.

Referring to FIG. 3F, in some embodiments, a part of a gate electrode may be removed from a device region. For example, as illustrated in FIG. 3F, a fourth insulating layer CT4 may be formed between first and second nanosheet stacks NS01 and NS02 in a first device region RX01, and a fifth insulating layer CT5 may be formed between third and fourth nanosheet stacks NS03 and NS04 in a second device region RX02. The fourth insulating layer CT4 may replace a lower portion of a gate electrode G01 in the first device region RX01, and the fifth insulating layer CT5 may replace a lower portion of the gate electrode G01 in the second device region RX02. The gate electrode G01 may have a reduced capacitance due to the portions removed by the fourth and fifth insulating layers CT4 and CT5. In some embodiments, as illustrated in FIG. 3F, the fourth insulating layer CT4 may be in contact with side surfaces of the nanosheets included in the first and second nanosheet stacks NS01 and NS02, and the fifth insulating layer CT5 may be in contact with side surfaces of the nanosheets included in the third and fourth nanosheet stacks NS03 and NS04.

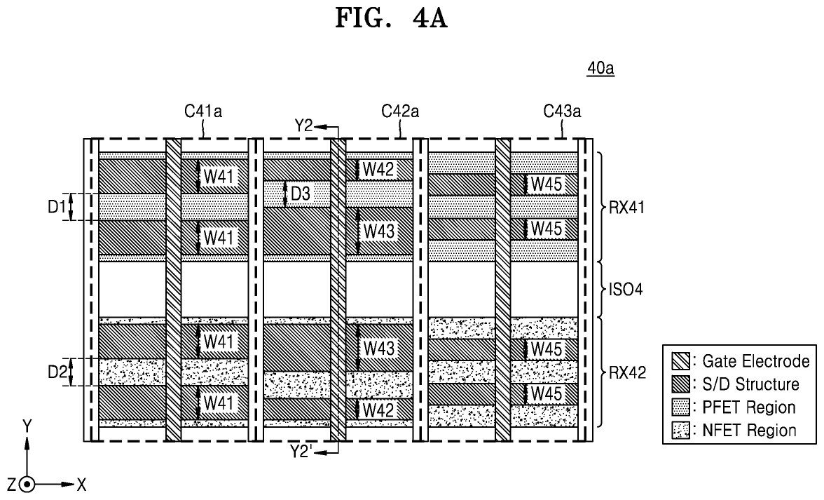

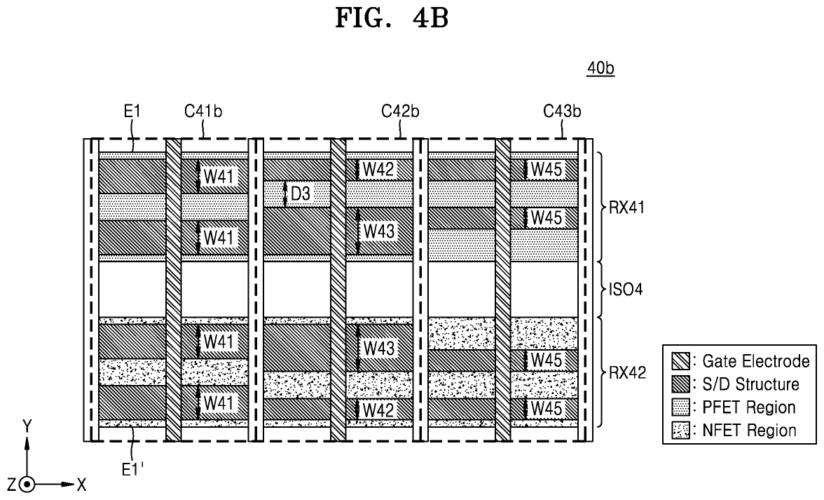

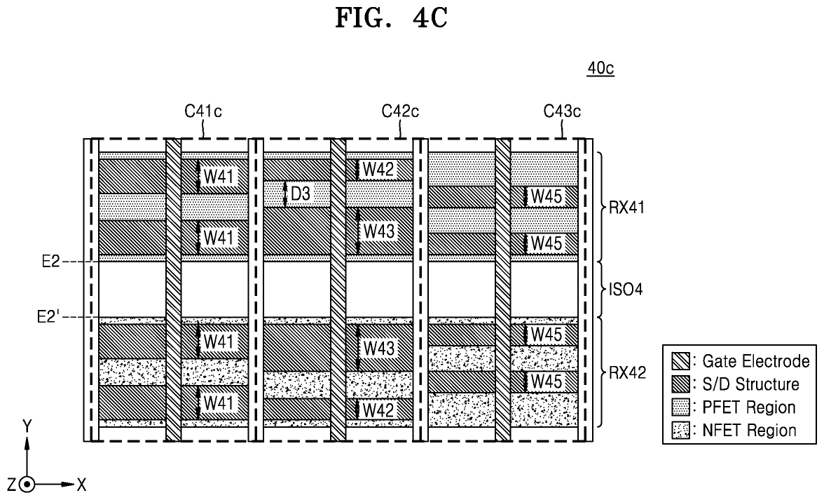

FIGS. 4A to 4C are plan views illustrating examples of layouts of integrated circuits according to example embodiments. Specifically, the plan views of FIGS. 4A to 4C illustrate cells including two active patterns (or two nanosheet stacks) in a device region. For the sake of convenient illustration, each of the cells of FIGS. 4A to 4C is illustrated as including one gate electrode, but example embodiments are not limited thereto. In addition, in FIGS. 4A to 4C, it is assumed that an active pattern has the same width as a width (that is, a length in the Y-axis direction) of a source/drain structure formed thereon. Hereinafter, repeated descriptions already given above are omitted from the description of FIGS. 4A to 4C.

Referring to FIG. 4A, an integrated circuit 40a may include a first cell C41a, a second cell C42a, and a third cell C43a arranged in the same row, and a first device region RX41 and a second device region RX42 and a device isolation layer IS04 may extend in the X-axis direction in the same row. Each of the first to third cells C41a to C43a may include two active patterns extending in the X-axis direction in the first device region RX41 and may include two active patterns extending in the X-axis direction in the second device region RX42. Each of the active patterns included in the first to third cells C41a to C43a may have a unique width. For example, as illustrated in FIG. 4A, the first cell C41 a may include two active patterns having a first width W41 in each of the first and second device regions RX41 and RX42. The second cell C42a may include two active patterns each having a second width W42 that is less than the first width W41 and a third width W43 that is greater than the first width W41 in each of the first and second device regions RX41 and RX42. The third cell C43a may include two active patterns having a fifth width W45 that is less than the first width W41 in each of the first and second device regions RX41 and RX42.

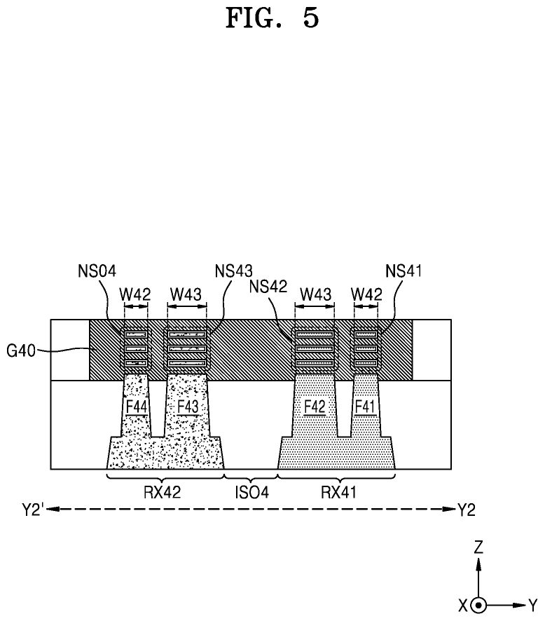

As illustrated in FIG. 4A, the active patterns in the first device region RX41 may be spaced apart by a first distance D1, and the active patterns in the second device region RX42 may be spaced apart by a second distance D2 in the second device region RX42. Lower bounds of the first distance D1 and the second distance D2 may be defined by a semiconductor process, and in some embodiments, the lower bound of the first distance D1 may be the same as the lower bound of the second distance D2. In some embodiments, distances between active patterns in the same device region may be the same as or different from each other. For example, the first distance D1 between the active patterns of the first cell C4la in the first device region RX41 may be different from a third distance D3 between the active patterns of the second cell C42a. An example of a cross-section taken along line Y2-Y2′ is described below with reference to FIG. 5.

Referring to FIG. 4B, an integrated circuit 40b may include a first cell C41b, a second cell C42b, and a third cell C43b arranged in the same row, and first and second device regions RX41 and RX42 and a device isolation layer IS04 may extend in the X-axis direction in the same row. The first to third cells C41b to C43b may each include two active patterns extending in the X-axis direction in the first device region RX41 and may each include two active patterns extending in the X-axis direction in the second device region RX42.

In some embodiments, active patterns may be aligned with each other based on an edge spaced apart from a device isolation layer among edges of a device region. For example, as illustrated in FIG. 4B, the active patterns in the first device region RX41 may be aligned with each other based on a first edge E1 of the first device region RX41, and active patterns in the second device region RX42 may be aligned with each other based on a first edge E1′ of the second device region RX42. Accordingly, among the active patterns of the first device region RX41, active patterns adjacent to the first edge E1 of the first device region RX41 may be spaced apart by the same distance from the first edge E1 of the first device region RX41. In addition, among the active patterns of the second device region RX42, active patterns adjacent to the first edge E1′ of the second device region RX42 may be spaced apart by the same distance from the first edge E1′ of the second device region RX42.

Referring to FIG. 4C, an integrated circuit 40c may include a first cell C41c, a second cell C42c, and a third cell C43c arranged in the same row, and first and second device regions RX41 and RX42 and a device isolation layer IS04 may extend in the X-axis direction in the same row. The first to third cells C41c to C43c may each include two active patterns extending in the X-axis direction in the first device region RX41 and may include two active patterns extending in the X-axis direction in the second device region RX42.

In some embodiments, active patterns may be aligned with each other based on an edge adjacent to a device isolation layer among edges of a device region. For example, as illustrated in FIG. 4C, active patterns in the first device region RX41 may be aligned with each other based on a second edge E2 of the first device region RX41, and active patterns in the second device region RX42 may be aligned with each other based on a second edge E2′ of the second device region RX41. Accordingly, among the active patterns of the first device region RX41, active patterns adjacent to the second edge E2 of the first device region RX41 may be spaced apart by the same distance from the second edge E2 of the first device region RX41. In addition, among the active patterns of the second device region RX42, active patterns adjacent to the second edge E2′ of the second device region RX42 may be spaced apart by the same distance from the second edge E2′ of the second device region RX42.

FIG. 5 is a cross-sectional view illustrating a cross-section of an integrated circuit according to an example embodiment. Specifically, the cross-sectional view of FIG. 5 illustrates an example of a cross-section taken along line Y2-Y2′ in the second cell C42a of FIG. 4A. As described above with reference to FIG. 4A, the second cell C42a may include active patterns having different second and third widths W42 and W43 in each of the first and second device regions RX41 and RX42.

Referring to FIG. 5, the first device region RX41, the device isolation layer IS04, and the second device region RX42 may be sequentially arranged in the Y-axis direction. In the first device region RX41, the first and second active patterns F41 and F42 may extend in parallel with each other in the X-axis direction, and in the second device region RX42, the third and fourth active patterns F43 and F44 may extend in parallel with each other in the X-axis direction. First to fourth nanosheet stacks NS41 to NS44 may be respectively formed over first to fourth active patterns F41 to F44, and each of the first to fourth nanosheet stacks NS41 to NS44 may include nanosheets stacked in the Z-axis direction. For example, the first and fourth nanosheet stacks NS41 and NS44 may include nanosheets having a second width W42, and the second and third nanosheet stacks NS42 and NS43 may include nanosheets having a third width W43 that is greater than the second width W42.

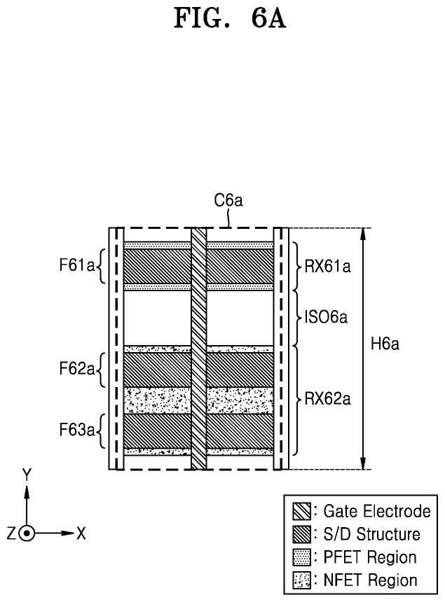

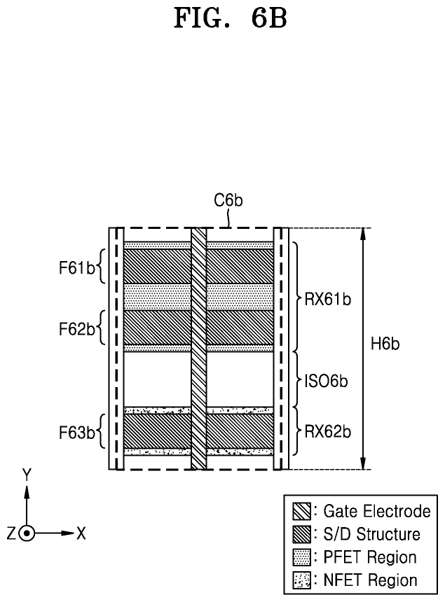

FIGS. 6A and 6B are plan views illustrating examples of cells included in an integrated circuit, according to example embodiments. For the sake of convenient illustration, each of cells C6a and C6b of FIGS. 6A and 6B is illustrated as including one gate electrode, but example embodiments are not limited thereto. In addition, in FIGS. 6A and 6B, it is assumed that active patterns have the same width as a width (that is, a length in the Y-axis direction) of a source/drain structure formed thereon. As described below with reference to FIGS. 6A and 6B, the cell may include a different number of active patterns (or nanosheet stacks) in each of the device regions.

Referring to FIG. 6A, the cell C6a may include a first active pattern F61a extending in the X-axis direction in a first device region RX61a and may include a second active pattern F62a and a third active pattern F63a extending in the X-axis direction in a second device region RX62a. Accordingly, the first device region RX61a may have a width (that is, a length in the Y-axis direction) that is less than a width (that is, a length in the Y-axis direction) of the second device region RX62a. As illustrated in FIG. 6A, the cell C6a may have a height H6a based on the total width of the first and second device regions RX61a and RX62a and the device isolation layer ISO6a.

Referring to FIG. 6B, a cell C6b may include a first active pattern F61b and a second active pattern F62b extending in the X-axis direction in a first device region RX61b and may include a third active pattern F63b extending in the X-axis direction in a second device region RX62b. Accordingly, the first device region RX61b may have a width (that is, a length in the Y-axis direction) that is greater than a width (that is, a length in the Y-axis direction) of the second device region RX62b. As illustrated in FIG. 6B, the cell C6b may have a height H6b based on the total width of the first and second device regions RX61b and RX62b and a device isolation layer ISO6b.

FIG. 7 is a plan view illustrating a layout of an integrated circuit according to an example embodiment. In some embodiments, the integrated circuit may include cells arranged in rows of different heights. Although FIG. 7 illustrates rows corresponding to three different heights, in some embodiments, the integrated circuit may also include rows corresponding to two different heights and in other embodiments, may include rows corresponding to three heights or more.

Referring to FIG. 7, an integrated circuit 70 may include a first cell C01, a second cell C02, and a third cell CO3 in a first row R71, and a fourth cell C04, a fifth cell C05, a sixth cell C06, and a seventh cell C07 in a second row R72 and may include an eighth cell C08, a ninth cell C09, a tenth cell C10, an eleventh cell C11, and a twelfth cell C12 in a third row R73. The first row R71 may have a width corresponding to a first height H71, the second row R72 may have a width corresponding to a second height H72, and the third row R73 may have a width corresponding to a third height H73. In some embodiments, the first height H71 may be greater than the third height H73, and the second height H72 may be less than the third height H73 (H71>H73>H72).

In some embodiments, the first to third cells C01 to C03 arranged in the first row R71 may provide a relatively high performance. For example, each of the first to third cells C01 to C03 may include two or more active patterns (or nanosheet stacks) extending in one device region. In some embodiments, the fourth to seventh cells C04 to C07 arranged in the second row R72 may provide reduced power consumption. For example, each of the fourth to seventh cells C04 to C07 may include one active pattern (or nanosheet stack) extending in one device region. In some embodiments, the eighth to twelfth cells C08 to C12 arranged in the third row R73 may perform less power consumption than the first to third cells C01 to CO3 arranged in the first row R71 and may provide a higher performance than the fourth to seventh cells C04 to C07 arranged in the second row R72.

FIG. 8 is a view illustrating a cell included in an integrated circuit according to an example embodiment. Specifically, a plan view of FIG. 8 illustrates layouts and equivalent circuits of inverter cells as multi-height cells sequentially arranged in two rows.

Referring to FIG. 8, inverter cells C8 may be sequentially arranged in a first row R81 and a second row R82 adjacent to each other. As illustrated in FIG. 8, the first row R81 may have a width corresponding to a first height H81, and the second row R82 may have a width corresponding to a second height H82 that is greater than the first height H81 (H82>H81). In the first row R81, a first device region RX81 and a second device region RX82 and a first device isolation layer IS081 may extend in the X-axis direction. A first active pattern F81 may extend in the X-axis direction in the first device region RX81, and a second active pattern F82 may extend in the X-axis direction in the second device region RX82. In addition, a third device region RX83 and a fourth device region RX84 and a second device isolation layer IS082 may extend in the X-axis direction in the second row R82. A third active pattern F83 and a fourth active pattern F84 may extend in the X-axis direction in the third device region RX83, and a fifth active pattern F85 and a sixth active pattern F86 may extend in the X-axis direction in the fourth device region RX84.

As described above with reference to FIG. 8, the cell arranged in the second row R82 may provide a higher performance than the cell arranged in the first row R81. The inverter cells C8 as multi-height cells sequentially arranged in the first and second rows R81 and R82 may provide a higher performance than an inverter cell which is a single-height cell arranged in the second row R82. The inverter cell C8 may include a first NFET NT81 including nanosheets formed over the third and fourth active patterns F83 and F84 and a second NFET NT82 including nanosheets formed over the second active pattern F82, and the first NFET NT81 may be connected in parallel to the second NFET NT82. In addition, the inverter cells C8 may include a first PFET PT81 including nanosheets formed over the fifth and sixth active patterns F85 and F86 and a second PFET PT82 including nanosheets formed over the first active pattern F81, and the first PFET PT81 may be connected in parallel to the second PFET PT82.

FIG. 9 is a plan view illustrating a layout of an integrated circuit according to an example embodiment. As illustrated in FIG. 9, an integrated circuit 90 may include cells arranged in a first row R91, a second row R92, and a third row R93, and each of the first to third rows R91 to R93 may have a width corresponding to a height H9.

In some embodiments, the integrated circuit 90 may include a cell that has a structure in which a cell consuming low power is expanded and that provides a high performance. For example, as illustrated in FIG. 9, a first cell C91 functioning as an inverter may be in the second row R92 and may include transistors including nanosheets formed on a first active pattern F91 and a second active pattern F92 extending in the X-axis direction. A second cell C92 providing a higher performance (for example, a higher operating speed) than the first cell C91 may be sequentially arranged in the first to third rows R91 to R93 and may have a height that is twice the height H9 of the first cell C91.

The second cell C92 may include a first NFET including nanosheets formed over a third active pattern F93 in the first row R91 and a second NFET including nanosheets formed over a fourth active pattern F94 in the second row R92, and the first NFET may be connected in parallel to the second NFET. In addition, the second cell C92 may include a first PFET including nanosheets formed over a fifth active pattern F95 in the second row R92 and a second PFET including nanosheets formed over a sixth active pattern F96 in the third row R93, and the first PFET may be connected in parallel to the second PFET. In some embodiments, a cell having a height double the height H9 like the second cell C92 may be adjacent to the second cell C92 in the Y-axis direction.

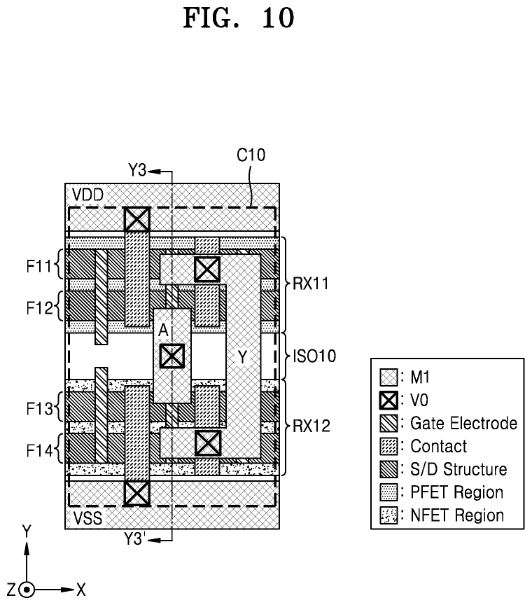

FIG. 10 is a plan view illustrating a cell included in an integrated circuit according to an example embodiment. Specifically, the plan view of FIG. 10 illustrates an inverter cell C10 functioning as an inverter that generates an output signal by inverting an input signal received through an input pin A and outputs the output signal through an output pin Y. Hereinafter, in describing FIG. 10, like reference designators refer to like elements and description already given with reference to FIG. 1 is omitted for conciseness.

As illustrated in FIG. 10, a first device region RX11 and a second device region RX12 may extend in the X-axis direction, and an isolation layer IS010 may extend in the X-axis direction between the first and second device regions RX11 and RX12. In the first device region RX11, a first active pattern F11 and a second active pattern F12 may extend in the X-axis direction, and in the second device region RX12, a third active pattern F13 and a fourth active pattern F14 may extend in the X-axis direction.

Compared with the first cell C01 of FIG. 1, a gate electrode may be terminated at an edge of an active pattern or a nanosheet in the inverter cell C10 of FIG. 10. For example, the gate electrode may extend to a power rail in the first cell C01 of FIG. 1, while the gate electrode may not overlap the power rail in the Z-axis direction in the inverter cell C10 of FIG. 10. Accordingly, the gate electrode of the inverter cell C10 of FIG. 10 may have a lower capacitance than the gate electrode of the first cell C01 of FIG. 1. Hereinafter, examples of a cross-section taken along line Y3-Y3′ are described below with reference to FIGS. 11A and 11B.

FIGS. 11A and 11B are cross-sectional views illustrating examples of a cross-section of an integrated circuit, according to example embodiments. Specifically, the cross-sectional views of FIGS. 11A and 11B illustrate examples of a cross-section taken along line Y3-Y3′ of the inverter cell C10 of FIG. 10. Hereinafter, like reference designators refer to like elements and repeated descriptions already given are above are omitted from the description of FIGS. 11A and 11B for conciseness.

In FIGS. 11A and 11B, the first device region RX11, the device isolation layer IS010, and the second device region RX12 may be sequentially arranged in the Y-axis direction. A first nanosheet stack NS11, a second nanosheet stack N12, a third nanosheet stack N13, and a fourth nanosheet stack NS14 may be respectively formed over the first to fourth active patterns F11 to F14. The first to fourth nanosheet stacks NS11 to NS14 may extend in the X-axis direction to pass through a gate electrode G10, and the gate electrode G10 may be connected to a pattern M11 through a gate a contact CA2 and a via V04. Although FIGS. 11A and 11B illustrate the first to fourth nanosheet stacks NS11 to NS14 each including three nanosheets, the nanosheet stacks may include nanosheets of various numbers, arrangements, and shapes as described above with reference to FIGS. 3A to 3C.

Referring to FIG. 11A, the gate electrode may be partially removed from an end of the gate electrode. For example, as illustrated in FIG. 11A, a first insulating layer CT11 may be formed adjacent to the first nanosheet stack NS11 in the first device region RX11, and a second insulating layer CT12 may be formed adjacent to the fourth nanosheet stack NS14 of the second device region RX12. The gate electrode G10 may be shortened by the first and second insulating layers CT11 and CT12, and thus, the gate electrode G10 may have a reduced capacitance.

Referring to FIG. 11B, a gate electrode may be partially removed from an end of the gate electrode, and a part of the gate electrode may be removed between device regions. For example, as illustrated in FIG. 11B, a first insulating layer CT11 may be formed adjacent to the first nanosheet stack NS11 in a first device region RX11, and a second insulating layer CT12 may be formed adjacent to a fourth nanosheet stack NS14 of a second device region RX12. In addition, a third insulating layer CT13 may be formed between a second nanosheet stack NS12 and the third nanosheet stack NS13, and the third insulating layer CT13 may replace a lower portion of a gate electrode G10 between the first and second device regions RX11 and RX12. The gate electrode G10 may have a capacitance reduced by the first to third insulating layers CT11 to CT13.

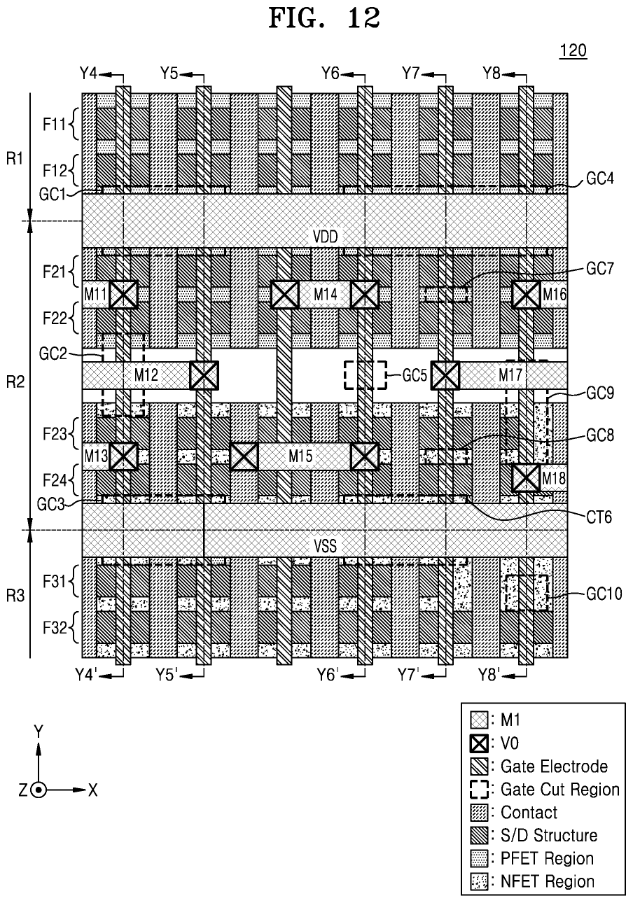

FIG. 12 is a plan view illustrating a layout of an integrated circuit according to an example embodiment. As illustrated in FIG. 12, an integrated circuit 120 may include a first row R1, a second row R2, and a third row R3 in which cells are arranged.

Referring to FIG. 12, two active patterns F11 and F12 may extend in a direction parallel to the X axis in the first row R1, and four active patterns F21 to F24 may extend in a direction parallel to the X axis in the second row R2, and two active patterns F31 and F32 may extend in a direction parallel to the X axis in the third row R3. In addition, a pattern of an M1 layer to which the positive supply voltage VDD is applied may extend in a direction parallel to the X axis on a boundary between the first and second rows R1 and R2, and a pattern of an M1 layer to which the negative supply voltage VSS is applied may extend in a direction parallel to the X axis on a boundary between the second and third rows R2 and R3. In addition, the integrated circuit 120 may include first to eighth patterns M11 to M18 of the M1 layer for routing signals in the second row R2.

In some embodiments, a part of the gate electrode may be removed by a gate cut region, and thus, the gate electrode may be separated into two or more gate electrodes. For example, as illustrated in FIG. 12, the integrated circuit 120 may include first to tenth gate cut regions GC1 to GC10. The gate cut region may refer to a region in which a part of the gate electrode is removed from the gate electrode formed to extend in a direction parallel to the Y-axis. For the sake of convenient illustration of FIG. 12, parts of the gate electrodes removed by the first to tenth gate cut regions GC1 to GC10 are not removed but are illustrated as they are.

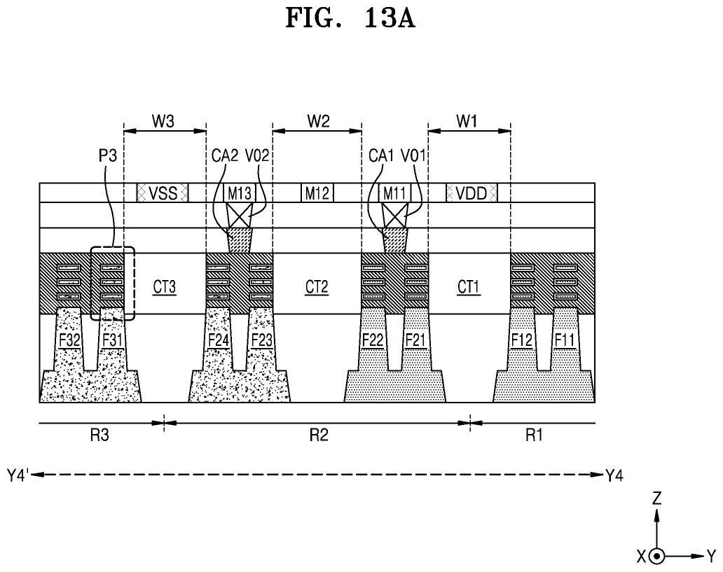

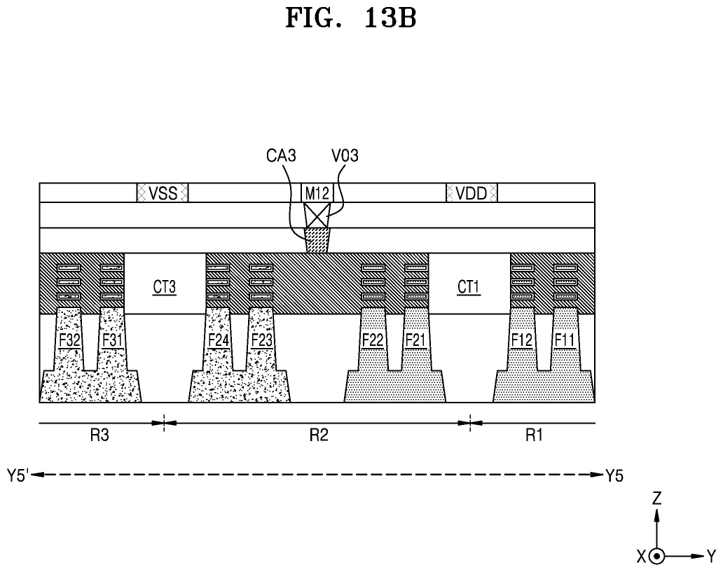

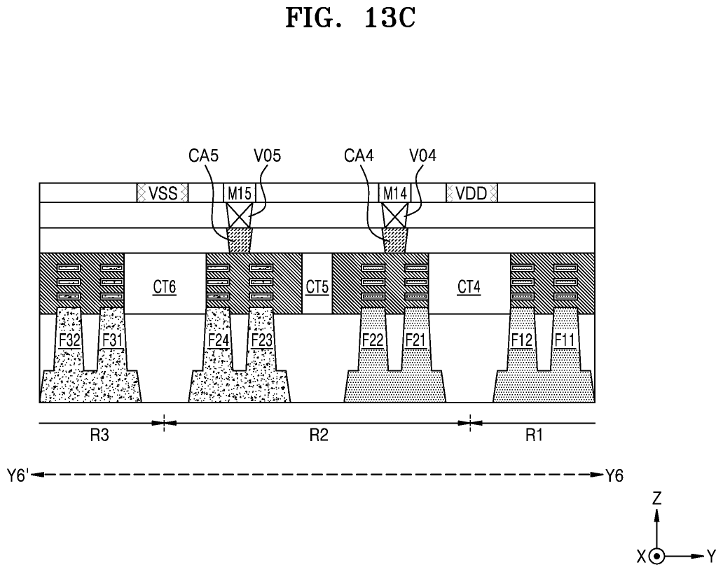

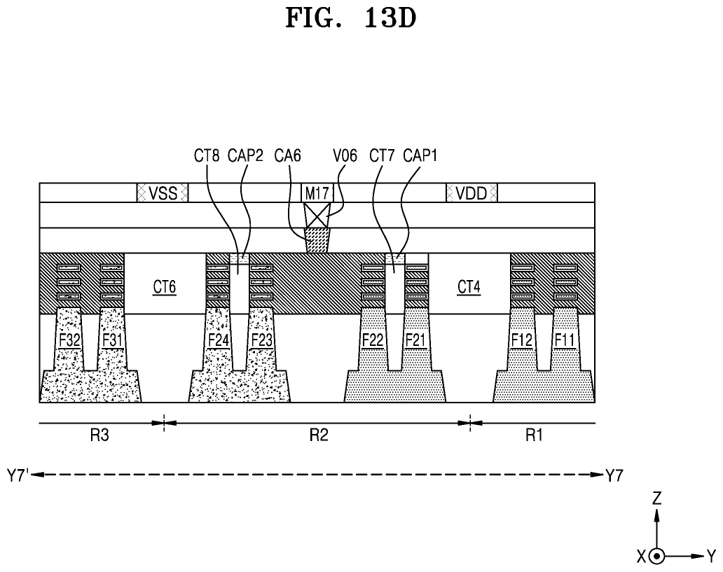

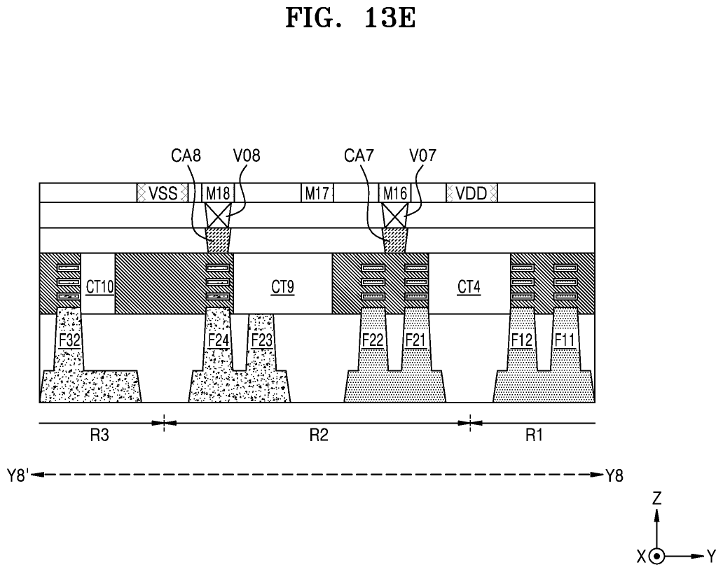

The gate cut regions may have various shapes. In some embodiments, the gate cut regions may be arranged to separate the gate electrode into two or more gate electrodes insulated from each other. In some embodiments, the gate cut regions may be arranged to reduce capacitances of gate electrodes, as described above with reference to FIG. 3D and so on. In some embodiments, the gate cut regions may be arranged to form transistors that provide a desired current driving capability. In some embodiments, the gate cut regions may be over two or more mutually adjacent gate electrodes extending in parallel. Hereinafter, cross-sections of the integrated circuit 120 taken along line Y4-Y4′, line Y5-Y5′, line Y6-Y6′, line Y7-Y7′, and line Y8-Y8′ in FIG. 12 are described below with reference to FIGS. 13A to 13E.

FIGS. 13A to 13E are cross-sectional views illustrating examples of cross-sections of an integrated circuit, according to an example embodiment. Specifically, the cross-sectional view of FIG. 13A illustrates an example of a cross-section of the integrated circuit 120 of FIG. 12 taken along line Y4-Y4′, the cross-sectional view of FIG. 13B illustrates an example of a cross-section of the integrated circuit 120 of FIG. 12 taken along line Y5-Y5′, the cross-sectional view of FIG. 13C illustrates an example of a cross-section of the integrated circuit 120 of FIG. 12 taken along line Y6-Y6′, the cross-sectional view of FIG. 13D illustrates an example of a cross-section of the integrated circuit 120 of FIG. 12 taken along line Y7-Y7′, and the cross-sectional view of FIG. 13E illustrates an example of a cross-section of the integrated circuit 120 of FIG. 12 taken along line Y8-Y8′. Hereinafter, FIGS. 13A to 13E are described with reference to FIG. 12.

Referring to FIG. 13A, two active patterns F11 and F12 may extend in parallel with each other in the X-axis direction in a first row R1, and two nanosheet stacks may be respectively over the two active patterns F 11 and F12. Four active patterns F21 to F24 may extend in parallel with each other in the X-axis direction in a second row R2, and four nanosheet stacks may be respectively over the four active patterns F21 to F24. A first pattern M11 may be connected to a gate electrode of a PFET through a first via V01 and a first contact CA1, and a third pattern M13 may be connected to a gate electrode of an NFET through a second via V2 and a second contact CA2. In a third row R3, two active patterns F31 and F32 may extend in parallel with each other in the X-axis direction, and two nanosheet stacks may be respectively over the two active patterns F31 and F32.

A first insulating layer CT1 may separate a gate electrode of the first row R1 from a gate electrode of the second row R2. For example, as illustrated in FIG. 13A, the first insulating layer CT1 may be on a boundary between the first and second rows R1 and R2 below a pattern (that is, a power rail) of an M1 layer to which the positive supply voltage VDD is applied. In addition, a third insulating layer CT3 may separate a gate electrode of the third row R3 from the gate electrode of the second row R2. For example, as illustrated in FIG. 13A, the third insulating layer CT3 may be on a boundary between the second and third rows R2 and R3 below a pattern (that is, a power rail) of an M1 layer to which the negative supply voltage VSS is applied. A second insulating layer CT2 may separate a gate electrode of an NFET from a gate electrode of a PFET in the second row R2. An example of a third portion P3 including a part of the third insulating layer CT3 and a nanosheet stack over the active pattern F31 is described below with reference to FIG. 16C.

In some embodiments, a length W2 of the second insulating layer CT2 in the Y-axis direction which separates a gate of the NFET from a gate of the PFET may be different from lengths W1 and W3, in the Y-axis direction, of the first and third insulating layers CT1 and CT3, respectively, arranged at row boundaries. For example, in the example of FIG. 13A, the length W2, in the Y-axis direction, of the second insulating layer CT2 may be greater than the lengths W1 and W3, in the Y-axis direction, of the first and third insulating layers CT1 and CT3 arranged in the row boundaries (W2>W1 and W2>W3).

Referring to FIG. 13B, in a first row R1, two active patterns F11 and F12 may extend in parallel with each other in the X-axis direction, and two nanosheet stacks may be respectively over the two active patterns F11 and F12. In a second row R2, four active patterns F21 to F24 may extend in parallel with each other in the X-axis direction, and four nanosheet stacks may be respectively over the four active patterns F21 to F24. A second pattern M12 may be connected to gate electrodes of an NFET and a PFET through a third via V03 and a third contact CA3. In a third row R3, two active patterns F31 and F32 may extend in parallel with each other in the X-axis direction, and two nanosheet stacks may be respectively over the two active patterns F31 and F32.

A first insulating layer CT1 may separate a gate electrode of the first row R1 from a gate electrode of the second row R2. For example, as illustrated in FIG. 13B, the first insulating layer CT1 may be on a boundary between the first and second rows R1 and R2 below a pattern (that is, a power rail) of an M1 layer to which the positive supply voltage VDD is applied. In addition, a third insulating layer CT3 may separate a gate electrode of the third row R3 from the gate electrode of the second row R2. For example, as illustrated in FIG. 13B, the third insulating layer CT3 may be on a boundary between the second and third rows R2 and R3 below a pattern (that is, a power rail) of an M1 layer to which the negative supply voltage VSS is applied.

Referring to FIG. 13C, in a first row R1, two active patterns F11 and F12 may extend in parallel with each other in the X-axis direction, and two nanosheet stacks may be respectively over the two active patterns F11 and F12. In the second row R2, four active patterns F21 to F24 may extend in parallel with each other in the X-axis direction, and four nanosheet stacks may be respectively over the four active patterns F21 to F24. A fourth pattern M14 may be connected to a gate electrode of a PFET through a fourth via V04 and a fourth contact CA4, and a fifth pattern M15 may be connected a gate electrode of an NFET through a fifth via V05 and a fifth contact CA5. In a third row R3, two active patterns F31 and F32 may extend in parallel with each other in the X-axis direction, and two nanosheet stacks may be respectively over the two active patterns F31 and F32.

A fourth insulating layer CT4 may separate a gate electrode of the first row R1 from a gate electrode of the second row R2. For example, as illustrated in FIG. 13C, a fourth insulating layer CT4 may be on a boundary between the first and second rows R1 and R2 below a pattern (that is, a power rail) of an M1 layer to which the positive supply voltage VDD is applied. In addition, a sixth insulating layer CT6 may separate a gate electrode of the third row R3 from the gate electrode of the second row R2. For example, as illustrated in FIG. 13C, a sixth insulating layer CT6 may be on a boundary between the second and third rows R2 and R3 below a pattern (that is, a power rail) of an M1 layer to which the negative supply voltage VSS is applied. A fifth insulating layer CT5 may separate a gate electrode of an NFET from a gate electrode of a PFET in the second row R2. As illustrated in FIG. 13C, the fifth insulating layer CT5 may not be in contact with the nanosheet stacks, and thus, a length of the fifth insulating layer CT5 in the Y-axis direction may be less than a length W2 of the second insulating layer CT2 of FIG. 13A in the Y-axis direction. In addition, in some embodiments, the length of the fifth insulating layer CT5 in the Y-axis direction may be less than lengths of the fourth and sixth insulating layers CT4 and CT6 in the Y-axis direction which are arranged in boundaries between rows.

Referring to FIG. 13D, in a first row R1, two active patterns F11 and F12 may extend in parallel with each other in the X-axis direction, and two nanosheet stacks may be respectively over the two active patterns F11 and F12. In a second row R2, four active patterns F21 to F24 may extend in parallel with each other in the X-axis direction, and four nanosheet stacks may be respectively over the four active patterns F21 to F24. A seventh pattern M17 may be connected to gate electrodes of a PFET and an NFET through a sixth via V06 and a sixth contact CA6. In a third row R3, two active patterns F31 and F32 may extend in parallel with each other in the X-axis direction, and two nanosheet stacks may be respectively over the two active patterns F31 and F32.

A fourth insulating layer CT4 may separate a gate electrode of the first row R1 from a gate electrode of the second row R2. For example, as illustrated in FIG. 13D, the fourth insulating layer CT4 may be on a boundary between the first and second rows R1 and R2 below a pattern (that is, a power rail) of an M1 layer to which the positive supply voltage VDD is applied. In addition, a sixth insulating layer CT6 may separate a gate electrode of the third row R3 from the gate electrode of the second row R2. For example, as illustrated in FIG. 13D, the sixth insulating layer CT6 may be on a boundary between the second and third rows R2 and R3 below a pattern (that is, a power rail) of an M1 layer to which the negative supply voltage VSS is applied.

A seventh insulating layer CT7 may be between nanosheet stacks in a PFET region, and an eighth insulating layer CT8 may be between nanosheet stacks in a NFET region. A length, in the Y-axis direction, of a gate electrode connected to the sixth contact CA6 may be less than a length, in the Y-axis direction, of a gate electrode connected to the third contact CA3 of FIG. 13B. Accordingly, a PFET and an NFET of which gate voltages are controlled by a seventh pattern M17 may have a lower current driving capability and a lower gate capacitance than a PFET and an NFET of which gate voltages are controlled by the second pattern M12 of FIG. 13B.

In some embodiments, a capping layer may be formed on an insulating layer. For example, as illustrated in FIG. 13D, a first capping layer CAP1 may be formed on the seventh insulating layer CT7, and a second capping layer CAP2 may be formed on the eighth insulating layer CT8. The first and second capping layers CAP1 and CAP2 may be formed of an insulator and may protect the seventh and eighth insulating layers CT7 and CT8. For example, the first and second capping layers CAP1 and CAP2 may include nitride and may protect the seventh and eighth insulating layers CT7 and CT8 from semiconductor sub-processes performed after the seventh and eighth insulating layers CT7 and CT8 are formed.

Referring to FIG. 13E, in a first row R1, two active patterns F11 and F12 may extend in parallel with each other in the X-axis direction, and two nanosheet stacks may be respectively over the two active patterns F11 and F12. In a second row R2, four active patterns F21 to F24 may extend in parallel with each other in the X-axis direction, and three nanosheet stacks may be respectively over the three active patterns F21, F22, and F24, while a nanosheet stack over the active pattern F23 may be omitted. In addition, in a third row R3, one active pattern F32 may extend in the X-axis direction, and a nanosheet stack may be over the active pattern F32. A sixth pattern M16 may be connected to a gate electrode through a seventh via V07 and a seventh contact CA7, and an eighth pattern M18 may be connected to a gate electrode through an eighth via V08 and an eighth contact CA8.

A fourth insulating layer CT4 may separate a gate electrode of the first row R1 from a gate electrode of the second row R2. For example, as illustrated in FIG. 13D, the fourth insulating layer CT4 may be on a boundary between the first and second rows R1 and R2 below a pattern (that is, a power rail) of an M1 layer to which the positive supply voltage VDD is applied. A tenth insulating layer CT10 may be in the third row R3 and terminate the gate electrode extending from the second row R2. A ninth insulating layer CT9 may remove a nanosheet stack over the active pattern F23 in the second row R2 and a gate electrode of a region including the nanosheet stack. In other words, the ninth insulating layer CT9 may replace a nanosheet stack that would otherwise be provided over the active pattern F23 in the second row R2 and also replace a portion of the gate electrode of the region including the replaced nanosheet stack. Accordingly, in the second row R2, a PFET may include two nanosheet stacks, while an NFET may include one nanosheet stack. As such, a gate cut region may be used in various ways to obtain a transistor having a desired performance.

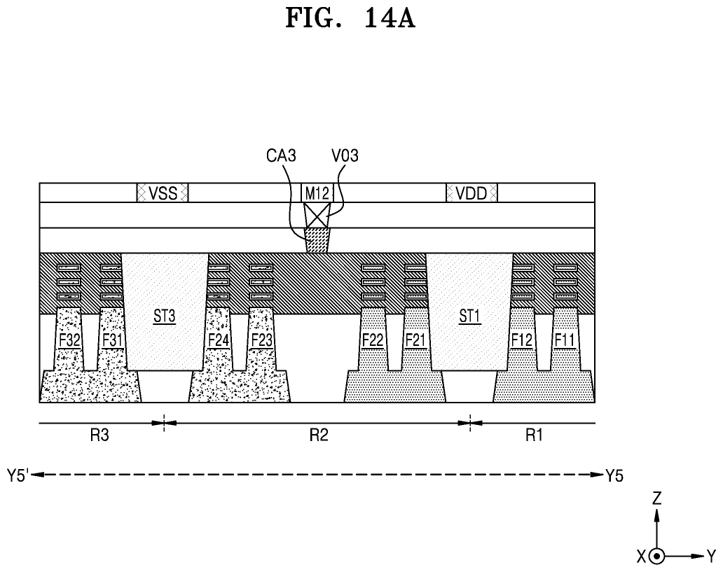

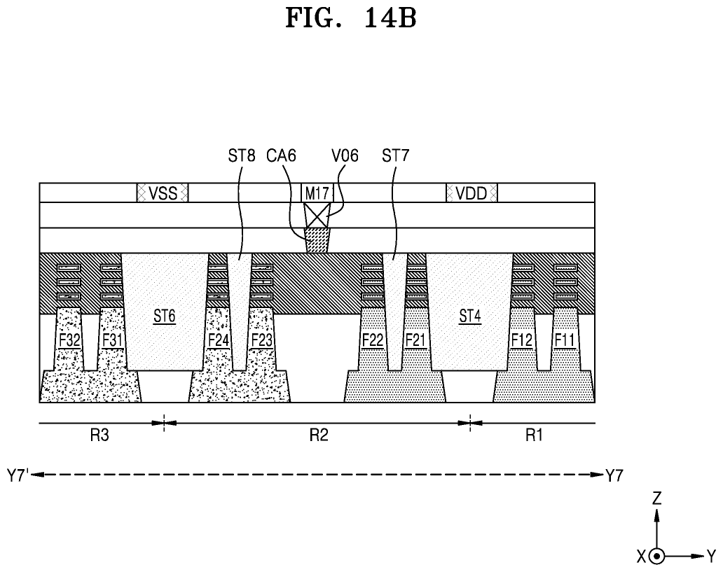

FIGS. 14A and 14B are cross-sectional views illustrating examples of cross-sections of an integrated circuit, according to an example embodiment. Specifically, the cross-sectional view of FIG. 14A illustrates an example of a cross-section of the integrated circuit 120 of FIG. 12 taken along line Y5-Y5′, and the cross-sectional view of FIG. 14B illustrates an example of a cross-section of the integrated circuit 120 of FIG. 12 taken along line Y7-Y7′. As illustrated in FIGS. 14A and 14B, a gate cut region may be formed by an insulating layer extending from a gate electrode to a side surface of an active pattern in the Z-axis direction. Hereinafter, FIGS. 14A and 14B will be described with additional reference to FIG. 12.

Referring to FIG. 14A, in a first row R1, two active patterns F11 and F12 may extend in parallel with each other in the X-axis direction, and two nanosheet stacks may be respectively over the two active patterns F11 and F12. In a second row R2, four active patterns F21 to F24 may extend in parallel with each other in the X-axis direction, and four nanosheet stacks may be respectively over the four active patterns F21 to F24. A second pattern M12 may be connected to gate electrodes of an NFET and a PFET through a third via V03 and a third contact CA3. In a third row R3, two active patterns F31 and F32 may extend in parallel with each other in the X-axis direction, and two nanosheet stacks may be respectively over the two active patterns F31 and F32.

A first insulating layer ST1 may separate a gate electrode of the first row R1 from a gate electrode of the second row R2. For example, as illustrated in FIG. 14A, the first insulating layer ST1 may be on a boundary between the first and second rows R1 and R2 below a pattern (that is, a power rail) of an M1 layer to which the positive supply voltage VDD is applied. In addition, a third insulating layer ST3 may separate a gate electrode of the third row R3 from the gate electrode of the second row R2. For example, as illustrated in FIG. 14A, the third insulating layer ST3 may be on a boundary between the second and third rows R2 and R3 below a pattern (that is, a power rail) of an M1 layer to which the negative supply voltage VSS is applied. As illustrated in FIG. 14A, the first and third insulating layers ST1 and ST3 may extend from the gate electrode to a side surface of the active pattern in the Z-axis direction.

Referring to FIG. 14B, in a first row R1, two active patterns F11 and F12 may extend in parallel with each other in the X-axis direction, and two nanosheet stacks may be respectively over the two active patterns F11 and F12. In a second row R2, four active patterns F21 to F24 may extend in parallel with each other in the X-axis direction, and four nanosheet stacks may be respectively over the four active patterns F21 to F24. A seventh pattern M17 may be connected to gate electrodes of a PFET and an NFET through a sixth via V06 and a sixth contact CA6. In a third row R3, two active patterns F31 and F32 may extend in parallel with each other in the X-axis direction, and two nanosheet stacks may be respectively over the two active patterns F31 and F32.

A fourth insulating layer ST4 may separate a gate electrode of the first row R1 from a gate electrode of the second row R2. For example, as illustrated in FIG. 14B, the fourth insulating layer ST4 may be on a boundary between the first and second rows R1 and R2 below a pattern (that is, a power rail) of an M1 layer to which the positive supply voltage VDD is applied. In addition, the sixth insulating layer ST6 may separate a gate electrode of the third row R3 from the gate electrode of the second row R2. For example, as illustrated in FIG. 14B, the sixth insulating layer ST6 may be on a boundary between the second and third rows R2 and R3 below a pattern (that is, a power rail) of an M1 layer to which the negative supply voltage VSS is applied. A seventh insulating layer ST7 may be between nanosheet stacks in a PFET region, and an eighth insulating layer ST8 may be between nanosheet stacks in an NFET region. As illustrated in FIG. 14B, the fourth, sixth, seventh, and eighth insulating layers ST4, ST6, ST7, and ST8 may extend from the gate electrodes to the side surfaces of the active patterns in the Z-axis direction.

The first and third insulating layers ST1 and ST3 of FIG. 14A and the fourth, sixth, seventh, and eighth insulating layers ST4, ST6, ST7, and ST8 of FIG. 14B may include any insulator. In some embodiments, the insulating layers of FIGS. 14A and 14B may include SiO₂, SiON, SiN, SiOCN, any other nitride, and/or metal oxide, and so on. In some embodiments, the insulating layers of FIGS. 14A and 14B may be formed of the same material as or a different material from a material of a device isolation layer such as shallow trench isolation (STI). In some embodiments, the insulating layers of FIGS. 14A and 14B may have a double layer structure including a liner and a filler, and the liner includes, for example, nitride, oxide and/or polysilicon.

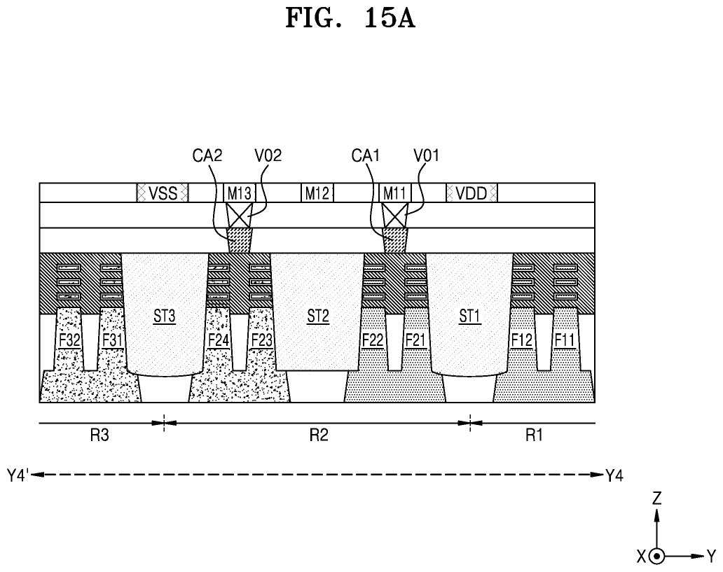

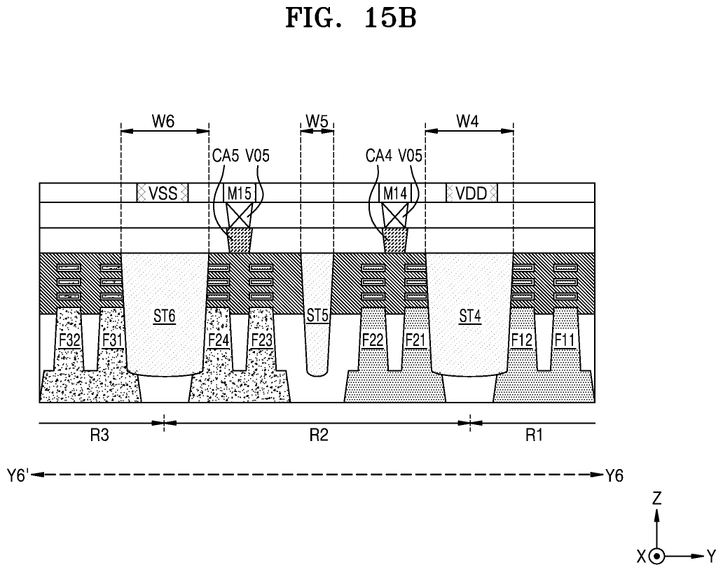

FIGS. 15A and 15B are cross-sectional views illustrating examples of cross-sections of an integrated circuit, according to an example embodiment. Specifically, the cross-sectional view of FIG. 15A illustrates an example of a cross-section of the integrated circuit 120 of FIG. 12 taken along line Y4-Y4′, and the cross-sectional view of FIG. 15B illustrates an example of a cross-section of the integrated circuit 120 of FIG. 12 taken along line Y6-Y6′. As illustrated in FIGS. 15A and 15B, a gate cut region may be formed by an insulating layer extending from a gate electrode to a side surface of an active pattern in the Z-axis direction. Hereinafter, FIGS. 15A and 15B will be described with additional reference to FIG. 12.

Referring to FIG. 15A, in a first row R1, two active patterns F11 and F12 may extend in parallel with each other in the X-axis direction, and two nanosheet stacks may be respectively over the two active patterns F11 and F12. In a second row R2, four active patterns F21 to F24 may extend in parallel with each other in the X-axis direction, and four nanosheet stacks may be respectively over the four active patterns F21 to F24. A first pattern M11 may be connected to a gate electrode of a PFET through a first via V01 and a first contact CA1, and a third pattern M13 may be connected to a gate electrode of an NFET through a second via V02 and a second contact CA2. In a third row R3, two active patterns F31 and F32 may extend in parallel with each other in the X-axis direction, and two nanosheet stacks may be respectively over the two active patterns F31 and F32.

A first insulating layer ST1 may separate a gate electrode of the first row R1 from a gate electrode of the second row R2. For example, as illustrated in FIG. 15A, the first insulating layer ST1 may be on a boundary between the first and second rows R1 and R2 below a pattern (that is, a power rail) of an M1 layer to which the positive supply voltage VDD is applied. In addition, a third insulating layer ST3 may separate a gate electrode of the second row R2 from a gate electrode of the third row R3. For example, as illustrated in FIG. 15A, a third insulating layer ST3 may be on a boundary between the second and third rows R2 and R3 below a pattern (that is, a power rail) of an M1 layer to which the negative supply voltage VSS is applied. A second insulating layer ST2 may separate a gate electrode of an NFET and a gate electrode of a PFET in the second row R2.

In some embodiments, lower surfaces of the first to third insulating layers ST1 to ST3 may be formed in various ways. For example, as illustrated in FIG. 15A, the lower surface of the second insulating layer ST2 may include a flat plane parallel to a plane consisting of the X axis and the Y axis, and each of the lower surfaces of the first and third insulating layers ST1 and ST3 may include a convex curved surface in the −Z-axis direction. In some embodiments, each of the lower surfaces of the first to third insulating layers ST1 to ST3 may include an inclined surface that is not parallel to a plane consisting of the X axis and the Y axis.

Referring to FIG. 15B, in a first row R1, two active patterns F11 and F12 may extend in parallel with each other in the X-axis direction, and two nanosheet stacks may be respectively over the two active patterns F11 and F12. In a second row R2, four active patterns F21 to F24 may extend in parallel with each other in the X-axis direction, and four nanosheet stacks may be respectively over the four active patterns F21 to F24. A fourth pattern M14 may be connected to a gate electrode of a PFET through a fourth via V04 and a fourth contact CA4, and a fifth pattern M15 may be connected to a gate electrode of an NFET through a fifth via V05 and a fifth contact CA5. In a third row R3, two active patterns F31 and F32 may extend in parallel with each other in the X-axis direction, and two nanosheet stacks may be respectively over the two active patterns F31 and F32.

A fourth insulating layer ST4 may separate a gate electrode of the first row R1 from a gate electrode of the second row R2. For example, as illustrated in FIG. 15B, the fourth insulating layer ST4 may be on a boundary between the first and second rows R1 and R2 below a pattern (that is, a power rail) of an M1 layer to which the positive supply voltage VDD is applied. In addition, a sixth insulating layer ST6 may separate a gate electrode of the third row R3 from the gate electrode of the second row R2 For example, as illustrated in FIG. 15B, the sixth insulating layer ST6 may be on a boundary between the second and third rows R2 and R3 below a pattern (that is, a power rail) of an M1 layer to which the negative supply voltage VSS is applied. A fifth insulating layer ST5 may separate the gate electrode of the NFET from the gate electrode of the PFET in the second row R2. As illustrated in FIG. 15B, the fifth insulating layer ST5 may not be in contact with the nanosheet stacks, and thus, a length W5 of the fifth insulating layer ST5 in the Y-axis direction may be less than the length W2 of the second insulating layer CT2 in the Y-axis direction in FIG. 13A (W5<W2). In addition, in some embodiments, the length W5 of the fifth insulating layer ST5 in the Y-axis direction may be less than the lengths W4 and W6 of the fourth and sixth insulating layers ST4 and ST6, respectively, at row boundaries in the Y-axis direction (W5<W4 and W5<W6).

As described above with reference to FIG. 15A, the lower surfaces of the fourth to sixth insulating layers ST4 to ST6 may be formed in various ways. For example, as illustrated in FIG. 15B, each of the lower surfaces of the fourth to sixth insulating layers ST4 to ST6 may include a convex curved surface in the −Z axis direction. In some embodiments, the lower surface of the fifth insulating layer ST5 having a relatively short length W5 in the Y-axis direction may have a curved surface having a smaller radius of curvature than the lower surfaces of the insulating layers ST4 and ST6 having relatively long Y-axis lengths W4 and W6

FIGS. 16A to 16C are cross-sectional views illustrating examples of cross-sections of an integrated circuit, according to example embodiments. Specifically, the cross-sectional view of FIG. 16A schematically illustrates an enlargement of the first portion P1 of FIG. 3D, the cross-sectional view of FIG. 16B schematically illustrates an enlargement of the second portion P2 of FIG. 3E, and the cross-sectional view of FIG. 16C schematically illustrates an enlargement of the third portion P3 of FIG. 13A. As illustrated in FIGS. 16A to 16C, a part of a gate electrode may be removed by an insulating layer located at a level close to the gate electrode and/or an insulating layer extending from an upper portion of the gate electrode to a side surface of an active pattern.

Referring to FIG. 16A, a first insulating layer CT1 may be formed between a PFET and an NFET, and a gate electrode of the PFET may be connected to a gate electrode of the NFET through a portion of the gate electrode extending in the Y-axis direction on the first insulating layer CT1. The first insulating layer CT1 may be in contact with a side surface of a second nanosheet stack N502 over a second active pattern F02 and in contact with a side surface of a third nanosheet stack N503 over a third active pattern F03. In some embodiments, as illustrated in FIG. 16A, a lower surface of the first insulating layer CT1 and a lower surface of the gate electrode may be at adjacent levels. In other words, in some embodiments, the lower surface of the first insulating layer CT1 and the lower surface of the gate electrode may be coplanar. In some embodiments, the first insulating layer CT1 may include polysilicon.

Referring to FIG. 16B, a third insulating layer CT3 may be in contact with a side surface of a fourth nanosheet stack NS04 over a fourth active pattern F04. As illustrated in FIG. 16B, a lower surface of the third insulating layer CT3 and a lower surface of a gate electrode may be at adjacent levels. In other words, in some embodiments, the lower surface of the third insulating layer CT3 and the lower surface of a gate electrode may be coplanar. In some embodiments, the third insulating layer CT3 may include polysilicon. The third insulating layer CT3 and the gate electrode may extend in the -Y-axis direction and may be terminated by an insulating layer STO. As illustrated in FIG. 16B, the insulating layer STO terminating the gate electrode may extend in the Z-axis direction from a level higher than the gate electrode to a level lower than the gate electrode, for example, a level of the fourth active pattern F04. In some embodiments, the insulating layer STO may include SiN.

Referring to FIG. 16C, an insulating layer ST31 may be in contact with a side surface of a fourth nanosheet stack NS04 over an active pattern F31. As illustrated in FIG. 16C, a lower surface of the insulating layer ST31 and a lower surface of a gate electrode may be at adjacent levels. In other words, in some embodiments, the lower surface of the insulating layer ST31 and the lower surface of the gate electrode may be coplanar. In some embodiments, the insulating layer ST31 may include polysilicon. The insulating layer ST31 and the gate electrode may be terminated by an insulating layer ST32. As illustrated in FIG. 16C, the insulating layer ST32 terminating the gate electrode may extend in the Z-axis direction from a level higher than the gate electrode to a level lower than the gate electrode, for example, a side surface of the active pattern F31. As illustrated in FIG. 16C, the insulating layers ST31 and ST32 may collectively correspond to the third insulating layer CT3 of FIG. 13A.

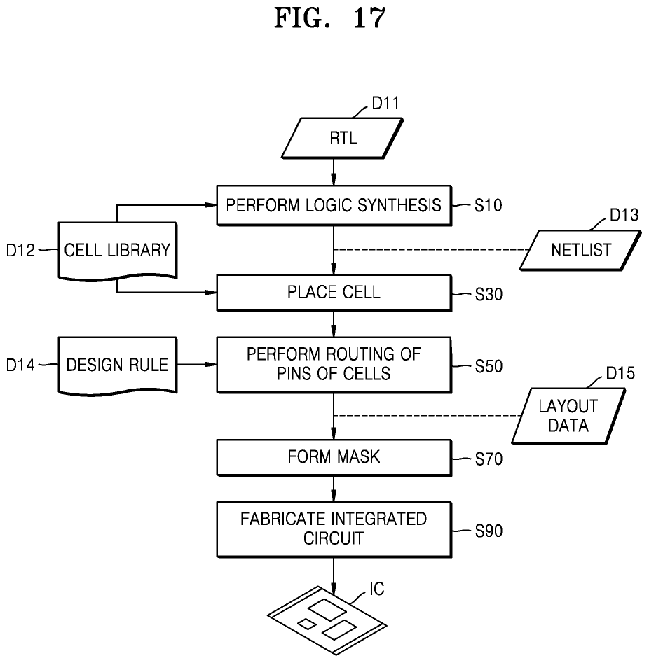

FIG. 17 is a flowchart illustrating a method of manufacturing an integrated circuit IC, according to an example embodiment. Specifically, the flowchart of FIG. 17 illustrates an example of a method of manufacturing the integrated circuit IC including cells with various properties. As illustrated in FIG. 17, the method of manufacturing the integrated circuit IC may include a plurality of operations S10, S30, S50, S70, and S90.

A cell library (or a standard cell library) D12 may include information on cells, for example, function information, characteristic information, layout information, and so on. In some embodiments, the cell library D12 may define cells with the same function and various properties as described above with reference to the drawings. For example, the cell library D12 may define a cell including one active pattern extending in one device region or may define a cell including a plurality of active patterns extending in one device region. In addition, the cell library D12 may also define cells with the same function and different heights. Due to the cell library D12 providing cells with various properties as described above, an integrated circuit IC having various properties and functions may be designed, configured and manufactured. A design rule D14 may include requirements that must be complied with to form a layout of the integrated circuit IC. For example, the design rule D14 may include requirements for a space between patterns, the smallest width of a pattern, a routing direction of a wiring layer, and so on. In some embodiments, the design rule D14 may define the minimum space within the same track of a wiring layer.

In operation S10, a logic synthesis operation for generating a netlist D13 from RTL data D1 may be performed. For example, a semiconductor design tool (for example, a logic synthesis tool) may perform logic synthesis with reference to the cell library D12 from RTL data D11 generated as hardware description language (HDL) such as VHSIC hardware description language (VHDL) and Verilog, thereby the netlist D13 including generating a bitstream or a netlist. The netlist D13 may correspond to an input of a place and routing, which will be described below.

In operation S30, cells may be placed. For example, a semiconductor design tool (for example, a place and routing (P&R) tool) may arrange cells used in the netlist D13 with reference to the cell library D12. In some embodiments, the semiconductor design tool may place additional cells (for example, pillar cells) in addition to the cells used in netlist D13.

In operation S50, routing of pins of the cells may be performed. For example, the semiconductor design tool may generate interconnections that electrically connect output pins and input pins of arranged cells and generate layout data D15 defining the arranged cells and the generated interconnections. The interconnections may include vias of via layers and/or patterns of wiring layers. The layout data D15 may have a format such as geometrical data base for information interchange (GDSII) and may include geometric information of cells and interconnections. The semiconductor design tool may refer to the design rule D14 while routing pins of cells. The layout data D15 may correspond to an output of placement and routing. Operation S50 alone, or both operation S30 and operation S50 may be referred to as a method of designing an integrated circuit.

In operation S70, a mask may be formed. For example, an operation of manufacturing a mask may be performed. For example, in photolithography, optical proximity correction (OPC) for correcting distortion such as refraction caused by characteristics of light may be applied to the layout data D15. Patterns on a mask may be defined to form patterns placed on a plurality of layers based on data to which OPC is applied, and at least one mask (or photomask) for forming patterns of each of a plurality of layers may be formed. In some embodiments, a layout of the integrated circuit IC may be limitedly modified in operation S70, and the limited modification of the integrated circuit IC in operation S70 is post-processing for improving a structure of the integrated circuit IC and may be referred to as design polishing.

In operation S90, an operation of fabricating the integrated circuit IC may be performed. For example, the integrated circuit IC may be fabricated by patterning a plurality of layers by using at least one mask formed in operation S70. A front-end-of-line (FEOL) may include, for example, an operation of performing planarization and cleaning of a wafer, an operation of forming a trench, an operation of forming a well, an operation of forming a gate electrode, and an operation of forming a source and a drain, and individual devices such as a transistor, a capacitor, and a resistor may be formed on a substrate by the FEOL. In addition, a back-end-of-line (BEOL) may include, for example, an operation of performing silicidation of a gate region, a source region, and a drain region, an operation of adding a dielectric, an operation of performing planarization, an operation of forming a hole, an operation of adding a metal layer, an operation of forming a via, an operation of forming a passivation layer, and so on, and individual devices such as a transistor, a capacitor, and a resistor may be connected to each other by the BEOL. In some embodiments, a middle-of-line (MOL) may be performed between the FEOL and the BEOL, and contacts may be formed on the individual devices. Subsequently, the integrated circuit IC may be packaged into a semiconductor package to be used as a component of various applications.

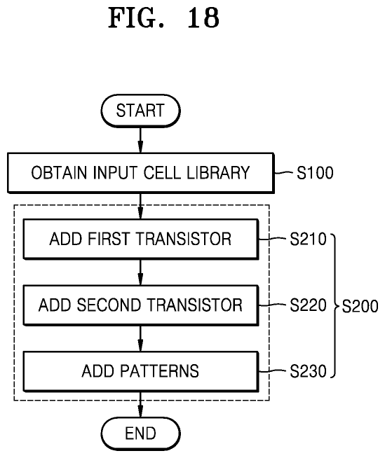

FIG. 18 is a flowchart illustrating a method of designing a cell of an integrated circuit, according to an example embodiment. As illustrated in FIG. 18, a method of designing a cell of an integrated circuit may include operation 5100 and operation 5200. In some embodiments, by using the method of FIG. 18, a cell providing a small area and less power consumption, such as the first cell C91 of FIG. 9 and a cell providing a high performance, such as the second cell C92 of FIG. 9 may be defined. Hereinafter, FIG. 18 will be described with additional reference to FIG. 9.

Referring to FIG. 18, an input cell library may be obtained in operation S100. For example, the input cell library may define cells, each having a structure in which one active pattern (or a nanosheet stack) extends in one device region, such as the first cell C91 of FIG. 9. As another example, the input cell library may define cells, each having a structure in which two or more active patterns (or nanosheet stacks) extend in one device region, such as the second cell C92 of FIG. 9 (see also FIG. 1). As described below, a cell providing a high performance may be easily defined from the previously defined cell, and thus, cells with various characteristics may be easily provided.

In operation S200, an output cell library may be generated. For example, the output cell library may define cells, each having a structure in which two or more active patterns (or nanosheet stacks) extend in one device region, such as the second cell C92 of FIG. 9. Hereinafter, a cell in the process of defining the second cell C92 may be referred to as a third cell. As illustrated in FIG. 18, operation S200 may include a plurality of operations S210, S220, and S230.

In operation S210, a first transistor may be added. For example, a first transistor included in a cell defined in input data may be added. For example, the first cell C91 may include a first PFET including a nanosheet stack formed over the first active pattern F91 and a first NFET including a nanosheet stack formed over the second active pattern F92, and the first PFET and the first NFET of the first cell C91 may be added to a third cell. Accordingly, the third cell may include a first PFET including a nanosheet stack formed over the fourth active pattern F94 and a first NFET including a nanosheet stack formed over the fifth active pattern F95.

In operation S220, a second transistor may be added. For example, a second transistor not included in a cell defined in the input data may be added. For example, transistors included in a row (for example, R91 or R93) adjacent to a row (for example, R92) including the first PFET and the first NFET added to the third cell may be added to the third cell. Accordingly, a second PFET including a nanosheet stack formed over the third active pattern F93 included in the first row R91 and a second NFET including a nanosheet stack formed over the sixth active pattern F96 included in the third row R93 may be added to the third cell.

In operation S230, patterns may be added. For example, patterns may be added to connect the first transistor added in operation S210 to the second transistor added in operation S220 in parallel. For example, a pattern of an M1 layer and/or a pattern of an M2 layer may be added to connect in parallel the first and second PFETs included in the third cell. In addition, the pattern of the M1 layer and/or the pattern of the M2 layer may be added to connect in parallel the first and second NFETs included in the third cell. As a result, the third cell may have the same structure as the second cell C92 of FIG. 9.

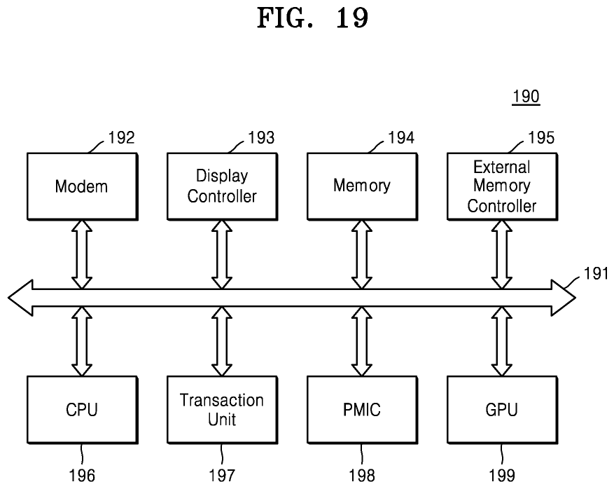

FIG. 19 is a block diagram illustrating a system-on-chip (SoC) according to an example embodiment. A system-on-chip 190 is a semiconductor device and may include an integrated circuit according to various example embodiments described above. The system-on-chip 190 implements complex functional blocks in one chip, such as intellectual property (IP) that performs various functions, and the system-on-chip 190 may be designed by a method of designing an integrated circuit according to various example embodiments, and thus, the system-on-chip 190 with the optimal performance, area, and efficiency may be implemented. Referring to FIG. 19, the system-on-chip 190 may include a modem 192, a display controller 193, a memory 194, an external memory controller 195, a central processing unit (CPU) 196, a transaction unit 197, a power management integrated circuit (PMIC) 198, and a graphic processing unit (GPU) 199, and respective functional blocks of the system-on-chip 190 may communicate with each other via a system bus 191.

The CPU 196 that may control an operation of the system-on-chip 190 in an uppermost layer may control operations of other functional blocks 192 to 199. The modem 192 may demodulate a signal received from the outside of the system-on-chip 190 or modulate a signal generated by the system-on-chip 190 and transmit the signal to the outside. The external memory controller 195 may control an operation of transmitting and receiving data from an external memory device connected to the system-on-chip 190. For example, a program and/or data stored in the external memory device may be provided to the CPU 196 or the GPU 199 under the control of the external memory controller 195. The GPU 199 may execute program instructions related to graphic processing. The GPU 199 may receive graphic data through the external memory controller 195 and may transmit graphic data processed by the GPU 199 to the outside of the system-on-chip 190 through the external memory controller 195. The transaction unit 197 may monitor data transactions of respective functional block, and the PMIC 198 may control power supplied to the respective functional blocks under the control of the transaction unit 197. The display controller 193 may transmit data generated by the system-on-chip 190 to a display (or a display device) by controlling the display in the outside of the system-on-chip 190. The memory 194 may include non-volatile memory such as electrically erasable programmable read-only memory (EEPROM) or flash memory and may also include volatile memory such as dynamic random access memory (DRAM) or static random access memory (SRAM).

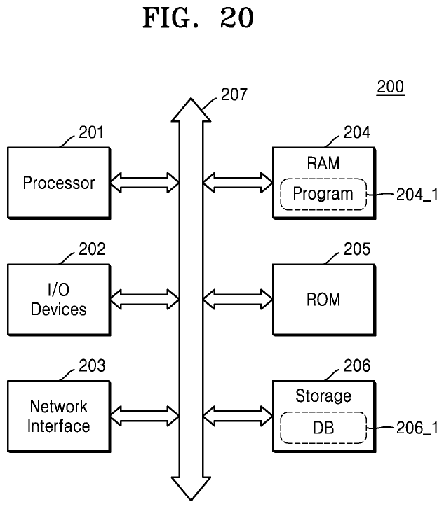

FIG. 20 is a block diagram illustrating a computing system including a memory for storing a program, according to an example embodiment. At least some of the operations included in a method of designing an integrated circuit, for example, the methods of FIGS. 17 and 18, according to example embodiments may be performed by a computing system (or a computer) 200.

The computing system 200 may include a stationary computing system such as a desktop computer, a workstation, or a server or may include a portable computing system such as a laptop computer. As illustrated in FIG. 20, the computing system 200 may include a processor 201, input/output (I/O) devices 202, a network interface 203, a random access memory (RAM) 204, a read only memory (ROM) 205, and a storage 206. The processor 201, the input/output devices 202, the network interface 203, the RAM 204, the ROM 205, and the storage 206 may be connected to a bus 207 to communicate each other via the bus 207.

The processor 201 may be referred to as a processing unit and may include at least one core capable of executing any instruction set (for example, Intel Architecture-32 (IA-32), 64-bit extended IA-32, x86-64, PowerPC, Sparc, million instructions per second (MIPS), asynchronous response mode (ARM), IA-64, or so on), such as, a microprocessor, an application processor (AP), a digital signal processor (DSP), or a graphic processing unit (GPU). For example, the processor 201 may access a memory, that is, the RAM 204 or the ROM 205, via the bus 207, and execute instructions stored in the RAM 204 or the ROM 205.

The RAM 204 may store a program 204_1 or at least a part thereof for a method of designing an integrated circuit according to an example embodiment, and the program 204_1 may cause the processor 201 to perform at least some of operations included in the method of designing the integrated circuit, for example, the methods of FIGS. 17 and 18. That is, the program 204_1 may include a plurality of instructions capable of being executed by the processor 201, and the plurality of instructions included in the program 204_1 may cause the processor 201 to perform at least some of operations included in, for example, the flowcharts of FIGS. 17 and 18.

The storage 206 may not lose stored data even when power supplied to the computing system 200 is disconnected. For example, the storage 206 may include a non-volatile memory device and may include a storage media such as a magnetic tape, an optical disk, and a magnetic disk. In addition, the storage 206 is removable from the computing system 200. In some embodiments, the storage 206 may store the program 204_1 according to an example embodiment, and the program 204_1 or at least a part thereof may be loaded into the RAM 204 from the storage 206 before the program 204_1 is executed by the processor 201. Alternatively, the storage 206 may store a file written in a programming language, and the program 204_1 generated from the file by a compiler or so on or at least a part thereof may be loaded into the RAM 204. In addition, as illustrated in FIG. 20, the storage 206 may store a database (DB) 206_1, and the database 206_1 may include information necessary for designing an integrated circuit, such as the cell library D12 and/or the design rule D14 of FIG. 17.

The storage 206 may store data to be processed by the processor 201 or data processed by the processor 201. That is, the processor 201 may generate data by processing data stored in the storage 206 according to the program 204_1 and may store the generated data in the storage 206. For example, the storage 206 may store the RTL data D11, the netlist D13, and/or the layout data D15 of FIG. 17.

The input/output devices 202 may include an input device such as a keyboard or a pointing device and may include an output device such as a display device or a printer. For example, a user may trigger execution of the program 204_1 by the processor 201 through the input/output devices 202 and may receive the RTL data D11 and/or the netlist D13 of FIG. 17 and may check the layout data D15 of FIG. 17.

The network interface 203 may provide a function of accessing an external network of the computing system 200. For example, a network may include multiple computing systems and communication links, and the communication links may include wired links, optical links, wireless links, or any other type of links.

While various example embodiments have been particularly shown and described with reference to the drawings, it will be understood that various changes in form and details may be made therein without departing from the spirit and scope of the following claims.

1. An integrated circuit comprising:
a first cell including a first transistor in which a plurality of nanosheets included in a first nanosheet stack and a second nanosheet stack extend in a first direction to pass through a first gate electrode that extends in a second direction intersecting with the first direction; and
a second cell including a second transistor in which at least one nanosheet included in a third nanosheet stack extends in the first direction to pass through a second gate electrode that extends in the second direction,
wherein a length of the first cell in the second direction is greater than a length of the second cell in the second direction.

2. The integrated circuit of claim 1, wherein the first cell includes a plurality of the first gate electrodes and the second cell includes a plurality of the second gate electrodes, and
a pitch between the first gate electrodes in the first cell is greater than a pitch between the second gate electrodes in the second cell.

3. The integrated circuit of claim 1, wherein the first cell includes first patterns formed in a lowermost wiring layer among a plurality of wiring layers,
wherein the second cell includes second patterns formed in the lowest wiring layer, and
wherein a pitch between the first patterns is greater than a pitch between the second patterns.

4. The integrated circuit of claim 3, wherein the first cell includes a first via connected to one of the first patterns,
wherein the second cell includes a second via connected to one of the second patterns, and
wherein the first via has a greater cross-sectional area than the second via.

5. The integrated circuit of claim 3, wherein the first patterns include a pattern including a first portion extending in the first direction and a second portion extending in the second direction, and
wherein the second patterns extend only in the first direction.

6. The integrated circuit of claim 1, wherein the second cell is in a first row extending in the first direction,
wherein the first nanosheet stack and the third nanosheet stack are aligned with each other in the first direction in the first row, and
wherein the second nanosheet stack is included in a second row adjacent to the first row.

7. The integrated circuit of claim 6, wherein the length of the first cell in the second direction is twice the length of the second cell in the second direction.

8. The integrated circuit of claim 1, wherein the integrated circuit includes a first row and a second row adjacent to the first row,
wherein the first cell is used in the first row and in the second row,
wherein the second cell is used in the first row,
wherein the first nanosheet stack and the second nanosheet stack are in the second row, and
wherein the first cell further includes a third transistor in which at least one nanosheet included in a fourth nanosheet stack in the first row extends in the first direction to pass through the first gate electrode.

9. The integrated circuit of claim 1, wherein the first nanosheet stack includes a nanosheet having a first width,
wherein the second nanosheet stack includes a nanosheet having a second width, and
wherein the first width is different from the second width.

10. The integrated circuit of claim 1, wherein a number of nanosheets included in the first nanosheet stack is different from a number of nanosheets included in the second nanosheet stack.

11. The integrated circuit of claim 1, wherein the first nanosheet stack includes nanosheets that are spaced apart from each other by a first distance and adjacent to each other,
wherein the second nanosheet stack includes nanosheets that are spaced apart by a second distance and adjacent to each other, and
wherein the first distance is different from the second distance.

12. The integrated circuit of claim 1, wherein the first nanosheet stack includes a nanosheet having a first thickness,
wherein the second nanosheet stack includes a nanosheet having a second thickness, and
wherein the first thickness is different from the second thickness.

13. The integrated circuit of claim 1, further comprising:
an insulating layer extending in the first direction while in contact with at least one of a side surface of the first nanosheet stack and a side surface of the second nanosheet stack.

14. The integrated circuit of claim 1, wherein the first cell and the second cell provide a same function and different performances.

15. An integrated circuit comprising:
a first device region and a second device region that extend in parallel with each other in a first direction;
a first device isolation layer extending in the first direction between the first device region and the second device region;
a first gate electrode extending in a second direction intersecting with the first direction;
a first active pattern extending in the first direction in the first device region;
a second active pattern extending in the first direction between the first device isolation layer and the first active pattern;
a first nanosheet stack including at least one nanosheet extending in the first direction over the first active pattern to pass through the first gate electrode; and
a second nanosheet stack including at least one nanosheet extending in the first direction over the second active pattern to pass through the first gate electrode.

16. The integrated circuit of claim 15, wherein the first nanosheet stack includes a nanosheet having a first width,
wherein the second nanosheet stack includes a nanosheet having a second width, and
wherein the first width is different from the second width.

17. The integrated circuit of claim 16, further comprising:
a second gate electrode extending in the second direction;
a third active pattern extending in the first direction in the first device region;
a fourth active pattern extending in the first direction between the first device isolation layer and the third active pattern;
a third nanosheet stack including at least one nanosheet extending in the first direction over the third active pattern to pass through the second gate electrode; and
a fourth nanosheet stack including at least one nanosheet extending in the first direction over the fourth active pattern to pass through the second gate electrode,
wherein the third nanosheet stack includes a nanosheet having a third width,
wherein the fourth nanosheet stack includes a nanosheet having a fourth width, and
wherein a sum of the first width and the second width is different from a sum of the third width and the fourth width.

18. The integrated circuit of claim 17, wherein the first nanosheet stack and the third nanosheet stack are spaced apart from a first boundary of the first device region by a first distance, and/or the second nanosheet stack and the fourth nanosheet stack are spaced apart from a second boundary of the first device region by a second distance.

19-25. (canceled)

26. The integrated circuit of claim 15, further comprising:
a third device region and a fourth device region respectively extending in parallel with the first device region and the second device region in the first direction; and
a second device isolation layer extending in parallel with the third device region and the fourth device region in the first direction between the third device region and the fourth device region,
wherein a total length of the first device region, the first device isolation layer, and the second device region in the second direction is greater than a total length of the third device region, the second device isolation layer, and the fourth device region in the second direction.

27. An integrated circuit comprising:
a first device region and a second device region that extend in parallel with each other in a first direction;
a first device isolation layer extending in the first direction between the first device region and the second device region;
a first gate electrode extending in a second direction intersecting with the first direction;
a plurality of first active patterns that extend in parallel with each other in the first direction in the first device region;
a plurality of first nanosheet stacks that each include at least one nanosheet extending in the first direction over each of the plurality of first active patterns to pass through the first gate electrode;
a plurality of second active patterns that extend in parallel with each other in the first direction in the second device region; and
a plurality of second nanosheet stacks that each include at least one nanosheet extending in the first direction over each of the plurality of second active patterns to pass through the first gate electrode.

28-29. (canceled)
